(19) United States
(12) Patent Application Publication
(10) Pub. No.: US 2026/0289041 A1
(43) Pub. Date: Sep. 24, 2026

(54) SYSTEM AND METHOD FOR MODELLING AND OPTIMIZING PHYSICAL SYSTEM IN WHICH MASS AND ENERGY TRANSFORM

(71) Applicant: McMASTER UNIVERSITY, Hamilton (CA)

(72) Inventors: Vladimir MAHALEC, Ancaster (CA); Farbod Maghsoudi, Hamilton (CA); Arman Khani, Hamilton (CA); Barnabas Osei, Hamilton (CA); Raunak Pandey, Hamilton (CA)

(21) Appl. No.: 19/575,126

(22) Filed: Mar. 23, 2026

Related U.S. Application Data
(60) Provisional application No. 63/775,726, filed on Mar. 21, 2025.

(51) Int. Cl. G06F 30/20; G06F 17/11; G06F 111/10

(52) U.S. Cl. CPC G06F 30/20; G06F 17/11; G06F 2111/10

(57) ABSTRACT

Methods and related systems for optimizing a physical system having interconnected equipment, between which matter and energy flow, are disclosed. In an aspect, the method comprises representing the physical system as a topology of nodes representing the equipment and streams representing transfer of matter/energy from one equipment towards another, where each node is associated with multiple sets of thermodynamic equations representing equipment operating behaviour at different levels of accuracy. The method includes modelling the physical system by generating sets of modelling equations based on selected node model equations. In another aspect, the method comprises modelling based on a first set of linearized mass-balance and energy-balance equations, in which mass flow is a variable and unit enthalpy is provided as a constant, and on a second linearized equation set, in which unit enthalpy, temperature and pressure are variables related by local property models.

This application claims the benefit under 35 U.S.C. 119(e) of U.S. provisional application Ser. No. 63/775,726 filed Mar. 21, 2025.

### TECHNICAL FIELD

The following relates to a system and method for optimizing a physical system in which mass and energy transform, for example, a processing plant.

### BACKGROUND

Over the last 60 years, great progress has been made in the ability to optimize process designs or plant operating conditions, to plan production over extended time horizons, and to schedule plant operations. Progress has been made in both algorithms and in commercially available software.

Software systems for optimization of plant design, operations, planning, and scheduling have been developed with specific business applications as targets, based on differing modelling paradigms, different architectures, and different algorithms.

Since the late 1960s plant modelling for process design and optimization of operating conditions has been based on describing process streams by mole fractions of individual components, total molar flow, temperature and pressure (moles & fractions paradigm). That enabled use of thermodynamic methods to calculate phase conditions of any stream, as well as development of first-principles based models of unit operations. Resulting plant models are highly nonlinear; they involve good initialization of individual unit models and of streams in the flowsheet model in order to converge. Sequential modular calculational algorithm, originating in 1960s, is still the prevailing solution procedure due to its ability to converge (slowly) almost any flowsheet. “Equation oriented” simultaneous solution of all flowsheet equations, commercially available since 1990s, has enabled optimization of entire plant models, provided that excellent initialization is provided. Most advanced applications based on this approach have been real-time optimization of large petrochemical plants (e.g. simultaneous RTO of two ethylene plants via a model containing more than 500 k equations as implemented by AspenTech in 1990s). Thousands of person-years have been invested in development of sophisticated process modelling software, enabling relatively straightforward process model configuration and solution (e.g. AspenPlus, Pro/II, Aspen HYSYS). Despite these efforts, models based on this paradigm are constrained to process design and single time-period optimization of operating conditions due to difficulties in converging them as their size grows. It is not possible to use them for multi-period planning or for scheduling.

On the other hand, production planning started to use mathematical models in the early 1950s by using linear programming models to blend gasoline and then proceeded to address the entire refinery production planning. These models were based on bulk properties and total stream flows (volumetric or mass). Operation of process units was represented by linearized models, which enabled solution of large-scale multi-period planning models. Planning models today still use the same paradigm, with some modifications to accommodate nonlinear models. Current systems include, e.g., Haverly GRTMPS and Aspen PIMS. Recent PIMS improvements (PIMS-AO) have introduced multiperiod optimization of nonlinear planning models.

Similarly, production scheduling employs models based on bulk flows and properties of streams.

In the late 1970s dynamic matrix controller (DMC), the first widely applied model predictive control (MPC) algorithm, was introduced bringing data-driven plant models into industrial practice. Since then, various forms of MPC have been developed and widely deployed.

Currently, plant models are built at different levels of abstraction and based on different topological representation of the plant which does not permit smooth transition from one level of abstraction to another, thereby creating gaps in decision making between planning, scheduling, RTO, and control (PSRC).

Grossman (2005) presented some of the challenges in enterprise-wide optimization (planning, scheduling, and RTO), pointing to difficulties arising from the large problem size, issues in integrating models across vastly different time scales, nonlinearity of process models, and different levels of abstraction among the models.

Andres-Martinez and Ricardez-Sandoval (2022) reviewed integration of scheduling and control (iSC) and of planning, scheduling, and control (iPSC) (they include dynamic RTO and MPC in the control layer). Pistikopolous et al (2024) reviewed various approaches to integrating PSRC layers. Research efforts are classified based on the length of the time horizon that is a basis for particular integration, e.g. (i) short horizon real-time (hours and minutes) integration of RTO and MPC, (ii) days and hours based integration of scheduling and RTO, (iii) days-hours-minutes integration of scheduling, RTO, and MPC, and (iv) months/weeks-days-hours-minutes integration of planning, scheduling, RTO, and MPC. They propose PAROC (PARametric Optimization and Control) framework to develop and evaluate receding horizon optimization policies. The framework relies on high fidelity model to derive its approximations of the process; approximate scheduling model with control dynamics or control model with scheduling decisions are the used to generate a family of optimal solutions corresponding to different states. These solutions are then employed in real time without solving the models in real time.

During the last one or two decades, more attention has been devoted to hybrid models which combine first principles with data-driven models. Zendehboudi et al. (2018) presented a review of different types of hybrid models and methods to create them. Du and Schmal (2024) presented an update view of relationships between data-driven, first principles, and hybrid models with explicit considerations on their applications in petrochemical industry. These efforts have accelerated recently with wide attention given to machine learning and AI methods in the process systems field. Not surprisingly, companies producing plant modelling software view hybrid unit models as just another variation of equipment models and promote that they be integrated as node models in moles & fractions paradigm flowsheet models. Unfortunately, that will not enable moles & fractions software to be used for anything else beyond what it does already. Imubit (2024) offers a streamlined creation and deployment of data-driven models for real-time unit optimization. However, purely data-driven models may not deal with complex process plants.

Current software and academic research are rooted in three different paradigms that originated decades ago: (i) design and optimization of operating conditions based on rigorous thermodynamic models that employ mole fractions and mole flows; (ii) multi-period production planning or scheduling models based on volumetric flows and linearized models of equipment; (ii) data-driven models for advanced process control.

Each current paradigm uses different plant representation (different plant topology) and different levels of abstraction without inheritance from one abstraction to another. That causes inconsistencies between decision making steps, extensive (mostly unsuccessful) efforts to eliminate these inconsistencies, and limits quality of the solutions that are obtained.

Common to all three paradigms is adherence to a paradigm-specific uniform abstraction level (level of detail/accuracy of models describing plant equipment) and to a single pass solution algorithms, i.e. generate all model equations at once and solve them.

Consequences of employing single abstraction level, based on different plant topologies, to the entire plant model are:

First principles plant models typically have tens of thousands of nonlinear equations which limits their use to a single time-period since multi-time period models are computationally non tractable for use in industrial practice.

Current planning and scheduling software systems cannot:
represent different sections of a plant at different level of abstraction
employ different levels of abstraction in different time periods which limits them to having the same level of accuracy for all time periods.

MPC models do not include mass and energy balances which make them unsuitable for representing plant operation in multi-period optimization models.

Further, solutions between planning, scheduling, RTO, and control are inconsistent.

Yet further, with current generation of software, it is not possible to construct multi-step composite algorithms, for instance:
Solve multiperiod mass balance and fixed stream unit enthalpy model (i.e. planning model)
Solve heat exchanger network model for the flows from above step.
Update stream enthalpies at the new stream temperatures.
Solve multiperiod mass and energy balances with updated stream unit enthalpies (i.e., plant wide optimization)

Process plants measure stream flows in volumetric or mass units, not in moles. Data driven models can be developed from measured plant data and will represent the plant as it is, without conversion to mole flows and mole fractions Such models can be easily integrated into a plant modelling platform if the latter also employs mass or volumetric unit and not mole flows and mole fractions.

Current production planning and scheduling models either do not include plant energy balances or they use approximate energy demands per unit of feed for each process unit without modelling heat exchange recovery subsystems, which leads to inaccuracies in computed energy usage. This may be so because energy is typically less expensive than the materials and CO2 emissions are not prioritized.

Current practice in calculating energy balances via rigorous models is to include the unit enthalpy as a function of the stream composition expressed as mole fractions and the stream pressure and temperature, which results in nonlinear equations, i.e. leading to the plant model that is difficult to solve.

Efforts to resolve the discrepancies arising from different plant network representations in different paradigms or to change the modelling paradigm have been limited to mapping constraints from one level of abstraction to another instead of focusing on generating all plant models from the same plant topology, as it is done in this work.

Prior research efforts have accepted the difference in modelling paradigms and have focused on reducing difficulties arising from nonlinearities of process models. For instance, research efforts have been put forth to:
i) Develop specialized algorithms for solving nonlinear first-principles models;
ii) Employ surrogate models;
iii) Derive specialized linearization procedures while retaining mole flows and fractions, i.e. still dealing with inherently nonlinear systems; and
iv) Develop multi-scale modelling while retaining moles & fractions paradigm, i.e. proceed along the path that is based on highly nonlinear models.

Process simulation and optimization re based on rigorous thermophysical properties and process unit models are based on total mole flows and mole fractions as attributes describing streams in a plant model, which leads to highly nonlinear models that are solved either via a sequential modular algorithm (CHESS or ASPEN) or via an equation-oriented approach, where all plant model equations are solved simultaneously, e.g., SPEEDUP, QUASILIN, ASCEND, gPROMS, Aspen RT-OPT, or IDAES modelling framework built on PYOMO. Among them, only gPROMS and IDAES can solve both steady-state and dynamic optimization problems. Algorithms employed in the equation-oriented approach can be classified as full-space, decomposition, metaheuristic, matheuristic, or data-driven.

Full-space algorithms use exact solution methods to solve optimization models. Specialized solvers for solving large-scale problems include, e.g., GUROBI and CPLEX for MILP, and IPOPT and KNITRO for NLP problems.

Decomposition algorithms have been used extensively to solve multi-period models. They can be classified as external and internal decomposition approaches.

External decomposition reformulates the problem into a master problem and subproblems. The master problem coordinates the solution of the subproblems, which are solved independently. Among many decomposition strategies, the two commonly used are:

Lagrangean decomposition, which is appropriate for problems with structure as shown in FIG. 17A. If complicating constraints are removed, the problem decomposes into several subproblems, while complicating constraints are included in the objective function. Multiperiod planning problems and multi-stage stochastic problems have this structure. Bi-level decomposition with Lagrangean decompositions have been compared with a full space method on a multisite capacity, production, and distribution planning problem. Lagrangean decomposition is particularly effective for large-scale MILP with linking constraints.

Generalized Benders decomposition, which applies to systems with complicating variables (FIG. 17B); fixing complicating variables decomposes the problem into blocks that are easier to solve. A process flowsheet model with a recycle is an example of such a structure, where recycle flow is the complicating variable. The master problem deals with complicating variables; the subproblem optimizes the remainder of the variables while keeping the values from the master problem. At each iteration, the master problem is augmented by additional constraints (Bender's cuts) that exclude the current master problem solution or possibly a set of potentially suboptimal solutions. Generalized Benders decomposition is effective for MINLP, structured convex programs.

Internal decomposition does not explicitly reformulate the problem. Instead, the solution is found by iteratively updating blocks of variables while keeping others fixed (Kang et al.). Schur decomposition eliminates a block of variables while representing exactly its relationship to the remaining block. Nested Schur decomposition recursively eliminates variables, block by block. Yoshio and Biegler present a nested Schur decomposition for solving multi-period optimization problems, which enables them to solve the nonlinear subproblems in parallel on multi-core machines.

On the other hand, the fixed-point block-iterative (block Gauss-Seidel) method approximates the coupling between the blocks by solving it iteratively, whereas Schur elimination computes the coupling exactly. The nested block iterative method is a multi-level approximation of nested Schur decomposition.

Grossman presents full-space and decomposition methods for MILP and MINLP problems.

Metaheuristic algorithms explore optimization space via methods that are often inspired by natural processes. Velasco et al. surveyed recently developed methods, while Hussain et al. reviewed earlier methods.

Matheuristic algorithms include a mathematical programming model and heuristics at different points of the algorithm. For instance, Kulkarni-Thaker et al. used differential evolution with LP subproblems to identify a set of globally optimal solutions in gasoline blending, while Hernandez-Perez et al. proposed a two-level algorithm to optimize water distribution for hydraulic fracking. The upper-level employs improved multi-objective differential evolution to compute the values of variables that become parameters in the lower-level linear model. Boschetti et al. provided an overview of various heuristic and metaheuristic methods combined with mathematical models.

Data-driven optimization relies on surrogate models that represent a system of input-output relationships via equations that are simpler to solve than rigorous models. Misener et al. consider conditions for robustness to uncertainties and accurate extrapolation. They discuss verification that the optimum of the surrogate corresponds to the optimum of the true model. Beykal et al. present a parallelized algorithm for constrained grey-box optimization, while Neufang et al. study the performance of various algorithms for optimization of surrogate models.

However, the current approach to solving plant models is to solve simultaneously all equations to attain a desired level of accuracy. This paradigm causes inconsistencies among solutions for planning, scheduling, and optimization of operating conditions, since each of these models have separate sets of equations that are based on different plant topology.

Yet further, simultaneous modular approaches presented in the literature are based on mole flows and mole fractions descriptions of streams; therefore, they retain a highly nonlinear model structure, even though the node models themselves are first-order linear approximations of the node behavior. In addition, they do not consider different levels of model abstractions, i.e., they cannot produce consistent solutions for different levels of model accuracy.

### SUMMARY

According to an aspect of the invention, there is provided a method for optimizing a physical system having plural interconnected pieces of equipment between which matter and energy flow, the method executable on one or more processors, the method comprising: representing the physical system as a topology comprising plural nodes and plural streams interconnecting the nodes, wherein the nodes are representative of the pieces of equipment and the streams are respectively representative of transfer of at least one of matter and energy from one piece of equipment towards another, each node being associated with plural sets of thermodynamic equations representative of operating behaviour of a corresponding one of the pieces of equipment at different levels of accuracy as to form a node model of the piece of equipment, wherein the plural sets of thermodynamic equations include:
a first set consisting of node model mass-balance equations in which mass flow is a variable;
a second set comprising node model mass-balance and energy-balance equations in which mass flow and unit enthalpy are variables, wherein unit enthalpy in the second set is derived from local material property models; and
a third set comprising node model mass-balance and energy-balance equations in which mass flow and unit enthalpy are variables, wherein unit enthalpy in the third set is derived from rigorous material property models;

providing an optimization objective function;
selecting, for each node of the topology, a desired level of accuracy corresponding to one of the sets of thermodynamic equations;
modelling the physical system, comprising generating, from the same topology, sets of modelling equations based on the selected sets of thermodynamic equations;
optimizing the model of the physical system with respect to the optimization objective function by solving the generated sets of modelling equations until a convergence condition is met; and
outputting solutions determined by optimization of the model of the physical system representing operating parameters of the pieces of equipment, for input to the physical system to effect actual operating behaviour thereof.

This provides an arrangement for modelling the physical system with a single topology regardless of level of accuracy or objective function.

In a case, the sets of thermodynamic equations further include:
a fourth set comprising linearized node model mass-balance and energy-balance equations in which mass flow is a variable and unit enthalpy is provided as a constant; and
a fifth set comprising linearized node model mass-balance and energy-balance equations in which unit enthalpy, temperature and pressure are variables related by the local material property models. Preferably, unit enthalpy is expressed per unit mass as to be unit enthalpy.

Preferably, when a respective one of the streams comprises mass flow, the stream is represented by component mass flows and bulk thermodynamic properties expressed per unit mass.

In a case, the topology is based on a process flow diagram representative of the physical system.

According to an aspect of the invention, there is provided a system for optimizing a physical system having plural interconnected pieces of equipment between which matter and energy flow, the system executable on one or more processors, the system comprising:
a topology building module to represent the physical system as a topology comprising plural nodes and plural streams interconnecting the nodes, wherein the nodes are representative of the pieces of equipment and the streams are respectively representative of transfer of at least one of matter and energy from one piece of equipment towards another, each node being associated with plural sets of thermodynamic equations representative of operating behaviour of a corresponding one of the pieces of equipment at different levels of accuracy as to form a node model of the piece of equipment, wherein the plural sets of thermodynamic equations include:
   a first set consisting of node model mass-balance equations in which mass flow is a variable;
   a second set comprising node model mass-balance and energy-balance equations in which mass flow and unit enthalpy are variables, wherein unit enthalpy in the second set is derived from local material property models; and
   a third set comprising node model mass-balance and energy-balance equations in which mass flow and unit enthalpy are variables, wherein unit enthalpy in the third set is derived from rigorous material property models;
an optimization specification module to provide an optimization objective function and to select, for each node of the topology, a desired level of accuracy corresponding to one of the sets of thermodynamic equations;
a model generation module to model the physical system, including to generate, from the same topology, sets of modelling equations based on the selected sets of thermodynamic equations;
an optimization computation module to optimize the model of the physical system with respect to the optimization objective function by solving the generated sets of equations until a convergence condition is met; and
an output module to output solutions determined by optimization of the model of the physical system representing operating parameters of the pieces of equipment, for input to the physical system to effect actual operating behaviour thereof.

In a case, the sets of thermodynamic equations further include: a fourth set comprising linearized node model mass-balance and energy-balance equations in which mass flow is a variable and unit enthalpy is provided as a constant; and
a fifth set comprising linearized node model mass-balance and energy-balance equations in which unit enthalpy, temperature and pressure are variables related by the local material property models.

Preferably, unit enthalpy is expressed per unit mass.

Preferably, when a respective one of the streams comprises mass flow, the stream is represented by component mass flows and bulk thermodynamic properties expressed per unit mass.

In a case, the topology is based on a process flow diagram representative of the physical system.

According to another aspect of the invention, there is provided a method for optimizing a physical system having plural interconnected pieces of equipment between which matter and energy flow, the method executable on one or more processors, the method comprising:
providing, for each piece of equipment, a pair of sets of thermodynamic equations representative of operating behaviour of the piece of equipment at different levels of accuracy as to form a model of the piece of equipment, wherein the sets of thermodynamic equations include:
   a first set comprising linearized node model mass-balance and energy-balance equations in which mass flow is a variable and unit enthalpy is provided as a constant; and
   a second set comprising linearized node model mass-balance and energy-balance equations in which unit enthalpy, temperature, and pressure are variables related by local material property models
modelling the physical system based on a representation of the physical system comprising nodes representative of the pieces of equipment and streams interconnecting the nodes and respectively representative of transfer of at least one of matter and energy from one piece of equipment towards another, each stream being represented by component mass flows and bulk thermodynamic properties expressed per unit mass or by energy flow, wherein modelling comprises:
   generating a first set of modelling equations based on the first set of thermodynamic equations for all the nodes in the representation; and
   generating a second set of modelling equations based on the second set of thermodynamic equations for all the nodes in the representation;
optimizing the model of the physical system with respect to an optimization objective function by iteratively, until a convergence condition is met:
   optimizing the first set of modelling equations where unit enthalpy is set to a prescribed value;
   calculating, based on non-linearized equations of the models of the equipment, dependent parameters on mass flow using the mass flow computed from optimization of the first set of modelling equations of a corresponding iteration;
   solving the second set of modelling equations for unit enthalpy, temperature, and pressure, where mass flow is set to a prescribed value based on optimization of the first set of modelling equations of the corresponding iteration; and
   calculating constituent parameters of the first and second sets of modelling equations based on the non-linearized equations of the models of the equipment and material property models and on solutions of the first and second sets of modelling equations of the corresponding iteration, which are usable in a subsequent iteration; and
outputting solutions determined by optimization of the model of the physical system representing operating parameters of the pieces of equipment, for input to the physical system to effect actual operating behaviour thereof.

This provides an arrangement for optimizing a physical system normally modelled by nonlinear systems of equations, which contain thousands of bilinear terms containing mass flow-multiplied by unit enthalpy (encountered in mass and energy balance equations), with rapid and robust convergence.

In a case, when the linearized mass-balance and energy-balance equations of at least one of the models of the pieces of equipment contain parameters other than mass flow, optimizing the model of the physical system includes, before optimizing the first set of modelling equations in an initial iteration, assigning values associated with normal operating conditions (NOC) of the physical system to said parameters other than mass flow.

In a case, calculating constituent parameters of the first and second sets of modelling equations based on the non-linearized equations of the models of the pieces equipment and the material property models comprises calculating mass flow, pressure and temperature solely based on the non-linearized equations of the models of the pieces of equipment and calculating parameters other than mass flow, pressure and temperature solely based on the local material property models.

In a case, after calculating material properties such as mass flow, pressure and temperature from local material property models, the method may further include updating local material property models from rigorous property models and continuing to iterate until local material property models have converged.

In a case, the method further includes inputting, to the pieces of equipment, the solutions determined by the optimization of the model, as to effect operation of the pieces of equipment.

In a case, the representation of the physical system is in the form of a topology based on a process flow diagram of the physical system.

In a case, the convergence condition comprises a mass flow convergence condition checked after optimizing the first set of modelling equations.

In one such case, solving the second set of modelling equations is performed after convergence of optimization of the first set of modelling equations.

In one such case, the convergence condition comprises an energy flow convergence condition checked after solving the second set of modelling equations, and optimization is complete when both the mass flow and energy flow convergence conditions are met. For example, the energy flow convergence condition is based on unit enthalpy or temperature.

According to another aspect of the invention, there is provided a system for optimizing a physical system having plural interconnected pieces of equipment between which matter and energy flow, the system executable on one or more processors, the system comprising:
a modelling module to:
   provide, for each piece of equipment, a pair of sets of thermodynamic equations representative of operating behaviour of the piece of equipment at different levels of accuracy as to form a model of the piece of equipment, wherein the sets of thermodynamic equations include:
   a first set comprising linearized mass-balance and energy-balance equations in which mass flow is a variable and unit enthalpy is provided as a constant; and
   a second set comprising linearized mass-balance and energy-balance equations in which unit enthalpy, temperature, and pressure are variables related by local material property models;
model the physical system based on a representation of the physical system comprising nodes representative of the pieces of equipment and streams interconnecting the nodes and respectively representative of transfer of at least one of matter and energy from one piece of equipment towards another, each stream being represented by component mass flows and bulk thermodynamic properties expressed per unit mass or by energy flow, wherein modelling comprises:
   generating a first set of modelling equations based on the first set of thermodynamic equations for all the nodes in the representation; and
   generating a second set of modelling equations based on the second set of thermodynamic equations for all the nodes in the representation;
an optimization module to optimize the model of the physical system with respect to an optimization objective function by iteratively, until a convergence condition is met:
   optimizing the first set of modelling equations where unit enthalpy is set to a prescribed value;
   calculating, based on non-linearized equations of the models of the equipment, dependent parameters of mass flow using the mass flow computed from optimization of the first set of modelling equations of a corresponding iteration;
   solving the second set of modelling equations for unit enthalpy, temperature, and pressure, where mass flow is set to a prescribed value based on optimization of the first set of modelling equations of the corresponding iteration; and
   calculating constituent parameters of the first and second sets of modelling equations based on the non-linearized equations of the models of the equipment and material property models and on solutions of the first and second sets of modelling equations of the corresponding iteration, which are usable in a subsequent iteration; and
   an output module to output solutions determined by optimization of the model of the physical system representing operating parameters of the pieces of equipment, for input to the physical system to effect actual operating behaviour thereof.

In a case, when the linearized mass-balance and energy-balance equations of at least one of the models of the pieces of equipment contain parameters other than mass flow, the optimization module is further configured to assign values associated with normal operating conditions (NOC) of the physical system to parameters other than mass flow before optimizing the first set of modelling equations in an initial iteration.

In a case, the optimization module is configured to calculate mass flow, pressure and temperature solely based on the non-linearized equations of the models of the equipment and to calculate parameters other than mass flow, pressure and temperature solely based on the local material property models.

In a case, the optimization module is further configured to update the parameters other than mass flow, pressure and temperature using rigorous property models, and to check for convergence of the local material property models based on the rigorous property model calculations.

In a case, the output module is further configured to input, to the pieces of equipment, the solutions determined by the optimization of the model, as to effect operation of the pieces of equipment.

In a case, the modelling module is configured to represent the physical system in the form of a topology based on a process flow diagram of the physical system.

In a case, the optimization module is configured such that the convergence condition comprises a mass flow convergence condition checked after optimizing the first set of modelling equations.

In one such case, the optimization module is configured to solve the second set of modelling equations after convergence of optimization of the first set of modelling equations.

In one such case, the optimization module is configured such that the convergence condition comprises an energy flow convergence condition checked after solving the second set of modelling equations, and optimization is complete when both the mass flow and the energy flow convergence conditions are met. For example, the energy flow convergence condition is based on unit enthalpy or temperature.

These and other aspects are contemplated and described herein. It will be appreciated that the foregoing summary sets out representative aspects of the invention to assist skilled readers in understanding the following detailed description.

### DESCRIPTION OF THE DRAWINGS

A greater understanding of the embodiments will be had with reference to the figures, in which:

FIG. 1 is a diagram of system for optimizing a physical system in which mass and energy is transformed, according to an embodiment;

FIG. 2 is a diagram of system for optimizing a physical system in which mass and energy is transformed, according to a variant of the embodiment of FIG. 1;

FIG. 3 is a diagram of method for optimizing a physical system in which matter and energy are transformed, according to an embodiment of an aspect of the present invention;

FIG. 4 is a diagram of a topology representing a physical system;

FIG. 5 is a diagram of method for optimizing a physical system in which matter and energy are transformed, according to an embodiment of another aspect of the present invention;

FIG. 6 is a partial diagram of method for optimizing a physical system in which matter and energy are transformed, according to a variation of the embodiment of FIG. 5;

FIG. 7 is a graph of optimization solutions at different abstraction levels;

FIG. 8 is a diagram of a prototypical process plant;

FIG. 9 depicts the node and stream abstraction levels, depending on calculation of stream unit enthalpy;

FIG. 10 are diagrams showing consistency among abstraction levels is based on the same plant topology;

FIG. 11 is a diagram mapping plant decision making processes to abstraction levels of a plant model;

FIG. 12 is a diagram showing convergence with local and with rigorous property calculations;

FIG. 13 is a diagram showing each of the plant sections modelled at different level of abstraction;

FIG. 14 is a diagram showing production of hydrogen from natural gas;

FIG. 15 is a diagram showing the integrated real time optimization and process control; and

FIG. 16 is a diagram showing integration of scheduling and control

FIGS. 17A and 17B illustrate problems with complicating constraints and with complicating variables, respectively;

FIG. 18A illustrate plant equations, and FIG. 18B illustrates partitioning the plant equations into plant-level material and energy balances and node model equations;

FIG. 19 illustrates a composite algorithm convergence path;

FIG. 20 illustrates a composite algorithm according to an embodiment of an aspect of the present invention;

FIG. 21 illustrates a simplified flow diagram of a blue hydrogen plant;

FIG. 22 illustrates a chart showing electricity import and export prices;

FIG. 23 illustrates a chart showing maximum carbon intensity (CI) constraint and hydrogen demand;

FIG. 24 illustrates a chart showing natural gas and impure recycled hydrogen consumption as fuels in a combined heat and power unit (CHP);

FIG. 25 illustrates a chart showing natural gas feed rate and water feed rate;

FIG. 26 illustrates a chart showing export of electricity to a grid;

FIG. 27 illustrates a chart showing total time and solve times vs. number of time periods; and

FIG. 28 illustrates a chart showing time spent at different steps of the composite algorithm.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

Any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

Unless otherwise indicated, the definitions and embodiments described in this and other sections are intended to be applicable to all embodiments and aspects of the present disclosure herein described for which they are suitable as would be understood by a person skilled in the art. It is also to be understood that the terminology used herein is for the purpose of describing particular aspects only and is not intended to be limiting.

Stream: A directed connection carrying material (and optionally energy) between two nodes, characterized by total mass flow MF, component mass flows {MFⱼ}, and bulk properties per unit mass (e.g., unit enthalpy H and heat capacity Cₚ) parameterized about normal operating conditions (NOC) (T⁰, P⁰).

Node: A unit operation or subnetwork mapping input component flows to output component flows and, where applicable, energy transfers. Each node supports multiple incarnations (abstraction levels).

Local Material Property Model: A relation that updates stream k bulk properties around NOC; e.g.,

$${H}_{k} = {H}_{k}^{0} + {C}_{p} ( {T}_{k} - {T}_{k}^{0} ) .$$

Abstraction Levels: A hierarchy of sets of equations describing plant model, starting from simple mass flows [MF], to energy balances described by mass flows and unit enthalpies at normal operating conditions [MF, H⁰], to mass flows fixed and unit enthalpies calculated from local material property models [MF⁰, H], to mass flows and unit enthalpies both calculated simultaneously [MF, H], to mass flows and unit enthalpies calculated from rigorous thermodynamic methods [MF, H_{rigorous}] that determine which balances/properties are active in a given node incarnation.

Composite Algorithm: A plant-level algorithm that solves models at [MF, H] or [MF, H_{rigorous}] abstraction level by employing two-phase iteration: Phase I solves a linear [MF, H⁰], model; Phase II solves a linear [MF⁰, H] energy model with mass flows fixed; stream properties are updated after Phase II. After convergence of the two-phase algorithm, physical properties of the stream may be optionally updated from rigorous thermodynamic methods and Phase I and Phase II resolved until the convergence of the stream properties is attained.

Critical-Stream Set [symbol] _{crit}: A configurable subset of streams designated for governed rigorous-property refresh (e.g., two-phase, high-sensitivity, or operating-window-tight streams).

Thresholds ΔT_{max,s}, ΔP_{max,s}: Stream-specific temperature and pressure deviations from NOCthat authorize rigorous refresh for stream s.

Relaxation Factors α: Scalars in (0,1] used to blend new property values into the model to promote stable convergence.

The accompanying figures show a system 10 and methods 50 and 100 for optimizing a physical system having plural interconnected pieces of equipment between which matter and energy flow. Typically, such a physical system is a processing plant, for example, for processing a physical material or substance, such as a chemical or compound.

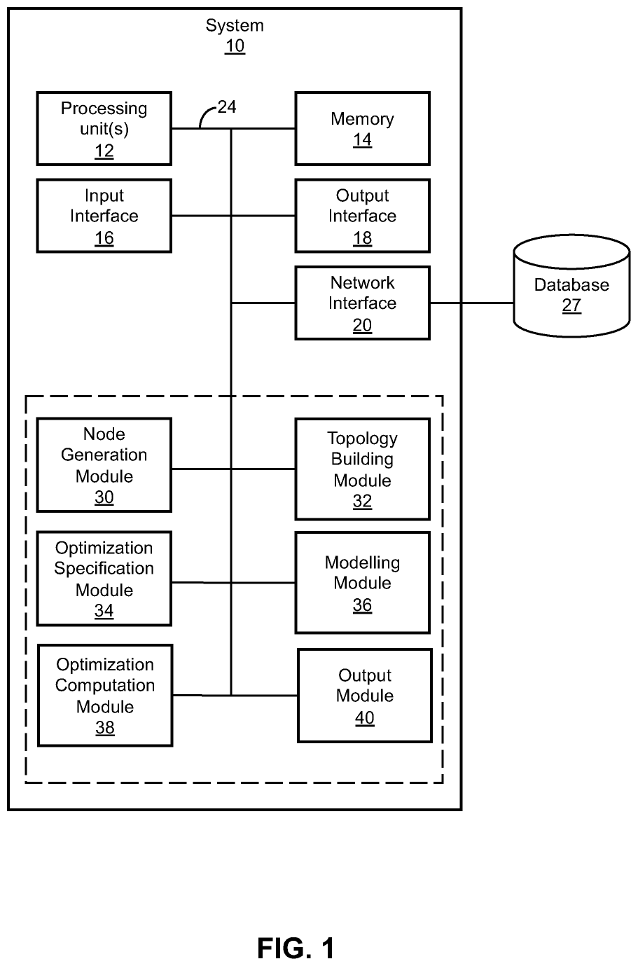

FIG. 1 shows a system 10 for optimizing a physical system, in accordance with an embodiment. The system 10 can be communicatively linked to a database 27. In an embodiment, the system 10 has a number of physical and logical components, including one or more processing units 12 (each comprising one or more processors), non-transitory memory 14, an input interface 16, an output interface 18, a network interface 20, and a bus 24, which may be implemented by internet communication protocol, enabling the one or more processing units 12 to communicate with the other components. The one or more processing units 12 execute various modules, as described below in greater detail, in addition to other operating systems and/or software. The memory 14 provides relatively responsive storage to the one or more processing units 12. The input interface 16 enables an operator or user to provide input via an input device, such as a keyboard, mouse, touchscreen, or the like. The output interface 18 outputs information to output devices, such as a display, screen, speakers, or the like. In some cases, the input interface 16 and the output interface 18 can be the same device (e.g., a touchscreen or tablet computer). The network interface 20 permits communication with other computing or storage devices, such as the database 27, which can be locally or remotely located from the system 10. The network interface 20 may also permit communication with various kinds of remote storage, such as cloud-based storage.

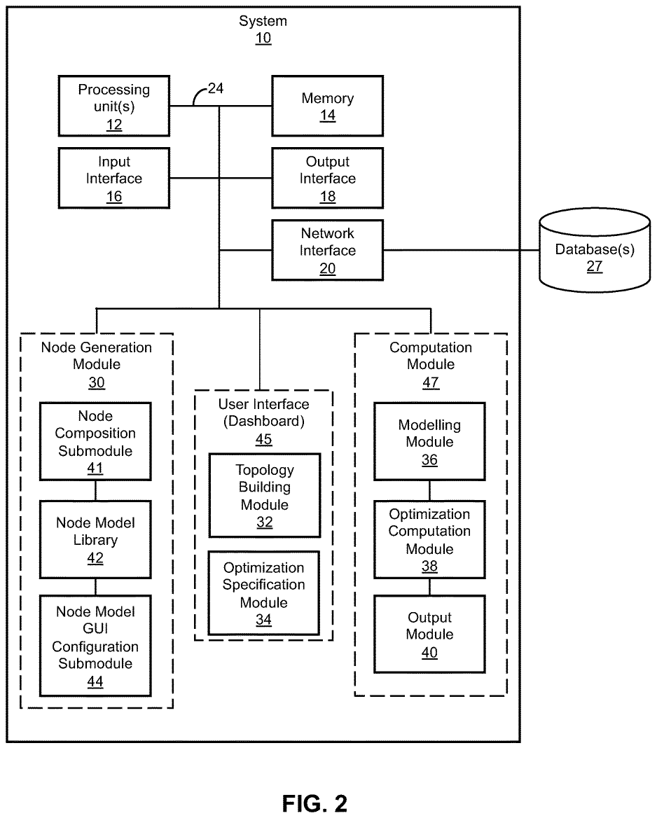

In various embodiments, the one or more processing units 12 can be configured to execute a number of conceptual and/or functional modules, for example, a node generation module 30, a topology building module 32, an optimization specification module 34, a modelling or model generation module 36, an optimization computation module 38, and an output module 40. Further, as shown in FIG. 2, the node generation module 32 may include a node composition submodule 41, a node model library submodule 42, and a node model graphical user interface (GUI) configuration submodule 44. Still referring to FIG. 2, the system may include a user interface, which includes the topology building module 32 and the optimization specification module 36. Further, a high-level computation module 47 may include the modelling module 36, the optimization computation module 38, and the output module 40. In further cases, functions of the above modules can be combined or executed on other modules. In some cases, functions of the above modules can be executed on remote computing devices, such as centralized servers and cloud computing resources communicating over the network interface 20.

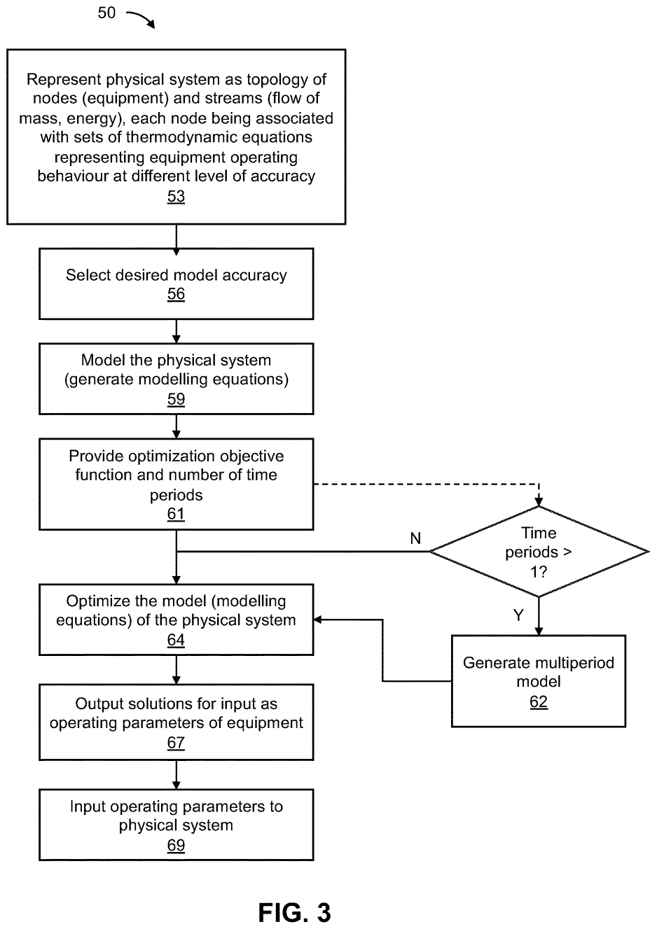

FIG. 3 illustrates a method 50 for optimizing a physical system, which is particularly suited for forming a topology of the physical system usable to generate modelling equations.

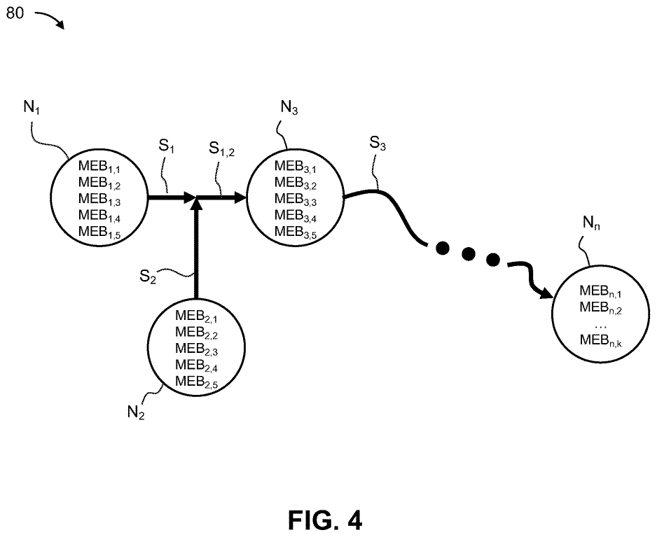

More specifically, at block 53, the topology building module 32 can represent the physical system as a topology 80. With reference to FIG. 4, the topology 80 comprises plural nodes, such as those indicated at N₁, N₂, through Nₙ, and plural streams interconnecting the nodes such as those indicated at S₁, S₂, S_{1,2}, and S₃. The nodes N are representative of the pieces of equipment, and the streams S are respectively representative of transfer of matter and/or energy from one piece of equipment towards another. Each node N is associated with plural sets, for example, k, of thermodynamic equations representative of operating behaviour of a corresponding piece of equipment at different levels of accuracy, such as those indicated at MEB_{n,1}, MEB_{n,2}, through through MEB_{n,k} when there are n pieces of equipment, as to form models of the equipment/nodes. Each stream S comprises mass flow and/or energy flow. When a stream comprises mass flow, the stream is by component mass flows (from the corresponding piece of equipment) and bulk thermodynamic properties of the material transferred at or by the corresponding stream S, expressed per unit mass. Bulk thermodynamic properties refer to overall or averaged physical properties of the material in the stream including, for example, temperature, pressure, volume, internal energy, entropy, enthalpy and heat capacity. In at least one case, the topology is based on a process flow diagram of the physical system.

In the illustrated embodiment, the sets of thermodynamic equations for each node include:
a first set consisting of mass-balance equations in which mass flow is a variable;
a second set comprising mass-balance and energy-balance equations in which mass flow and unit enthalpy are variables, where unit enthalpy in the second set is derived from local material property models;
a third set comprising mass-balance and energy-balance equations in which mass flow and unit enthalpy are variables, where unit enthalpy in the third set is derived from rigorous material property models;
a fourth set comprising linearized mass-balance and energy-balance equations in which mass flow is a variable and unit enthalpy is provided as a constant; and
a fifth set comprising linearized mass-balance and energy-balance equations in which unit enthalpy, temperature and pressure are variables related by the local material property models.

It will be appreciated that in the above-listed equation sets associated with the nodes there may be other variables besides mass flow or unit enthalpy, which are not set to a prescribed constant value, and thus will be solved during optimization.

Further, it will be appreciated that the linearized mass-balance and energy-balance equations of which the fourth and fifth node model equation sets are comprised are different.

The various node equation sets above may be informally referred to as ‘levels of abstraction’ for each node, denoting the relationship to level of accuracy. The sets of equations defining operating behaviour of a respective equipment may be referred to as a node model, and hence, the afore-referenced level of accuracy relates to that of the node model. Typically, the node models have at minimum the first, second and third equation sets, that is, levels of abstraction, and preferably, further includes the fourth and fifth sets, which the inventors have found improves computational speed of a computer configured or programmed to optimize the physical system according to the method 50. Further, unit enthalpy is preferably expressed per unit mass, rather than per unit mol, particularly when modelling using the fourth and fifth equation sets, as will be better appreciated shortly.

Further, it will be appreciated that local material property models comprise linear (thermodynamic) equations representative of a narrow range around a reference point, and rigorous material property models comprises nonlinear (thermodynamic) equations representing a broader range. Both types of models represent behaviour of materials present in the physical system, which may be input materials or byproducts formed as a result of the processes performed by the equipment.

As such, the same topology is used for all levels of plant model abstraction.

Referring back to FIG. 3, at block 56 the optimization specification module 34 can select one of the equation sets for each node based on a desired level of model accuracy which is typically provided by the user. In other words, the optimization specification module 34 can select a desired level of model accuracy corresponding to one of the sets of the node equations. In many but not all cases, the same abstraction level will be selected for the entire topology, and thus, the corresponding equation set for all the nodes may be provided simultaneously, that is, in parallel.

At block 59, the modelling module 36 can model the physical system. Modelling, by the modelling module 36, can include generating, from the same topology, sets of modelling equations based on the selected abstraction levels.

At block 61, the optimization specification module 34 can provide the optimization objective function. Typically, the objective function is provided through the module 34 by a user, for example, by manual input or by selection from a list of predetermined objective functions. Further, in some cases, the optimization specification module 34 can also provide a number of time periods to be represented in the model of the physical system. In some cases, the objective function provided by the user is generated by the modelling module 36 for subsequent use by the optimization computation module 38.

If a number of time periods specified by the optimization specification module 34 is greater than one, at block 62 multiperiod model is generated. In this instance, the multiperiod model of the physical system comprises plural models of the physical system (that is, the same model generated at block 59 replicated based on the number of time periods) which are interconnected.

At block 64, the optimization computation module 38 can optimize the model of the physical system by solving the generated sets of equations until a convergence condition is met. This module may also be referred to more simply as the optimization module, as it is the module responsible for computing or solving equations.

At block 67, the output module 40 can output solutions determined by optimization of the model of the physical system. The solutions represent operating parameters of the pieces of equipment of the physical system, and can be input to the physical system to effect actual operating behaviour thereof.

At block 69, the output module 40 can optionally input the operating parameters to the physical system, for example, by the output interface 18 which is communicatively coupled with the respective pieces of equipment in the physical system.

In some cases, the method 50 can comprise a step of forming the nodes for use in the topology. In such cases, the node generation module 30 can perform this step, and more specifically, the node composition submodule 41 can be invoked by the user to define the thermodynamic equations describing equipment operating behaviour. The node composition submodule 41 can retrieve stream attribute classes from a database such as 27. The thermodynamic equations composed using submodule 41 can be stored in the node model library for subsequent retrieval by the topology building module 32 at block 53. The node model GUI configuration submodule 44 can generate an icon to be stored in the node model library 44 in association with a corresponding node model.

Referring back to FIG. 2, the input interface 16 can be presented to the user in the form of user interface/dashboard 45, from which the topology building module 32 and optimization specification module 36 are available. Thus, the user can provide user-input to these modules to instantiate the model of the physical system for subsequent optimization. In a case, the topology formed by the topology building module 32 is stored on a database such as 27.

Still referring to FIG. 2, the modelling module 36 can receive the topology representing the physical system from the topology building module 32 and the selected levels of abstraction from the optimization specification module 36. Alternatively, the modelling module 36 can retrieve the topology from a database such as 27. The optimization (computation) module 38 can retrieve the optimization objective function from the optimization specification module 36 and the modelling equations from the modelling module 36. Further, the output module 40 can store the solutions of optimization in a database such as 27.

In the foregoing manner, there is provided an arrangement to form a common topology, that is, a single topology, of a physical system for modelling the same in an optimization regardless level of abstraction.

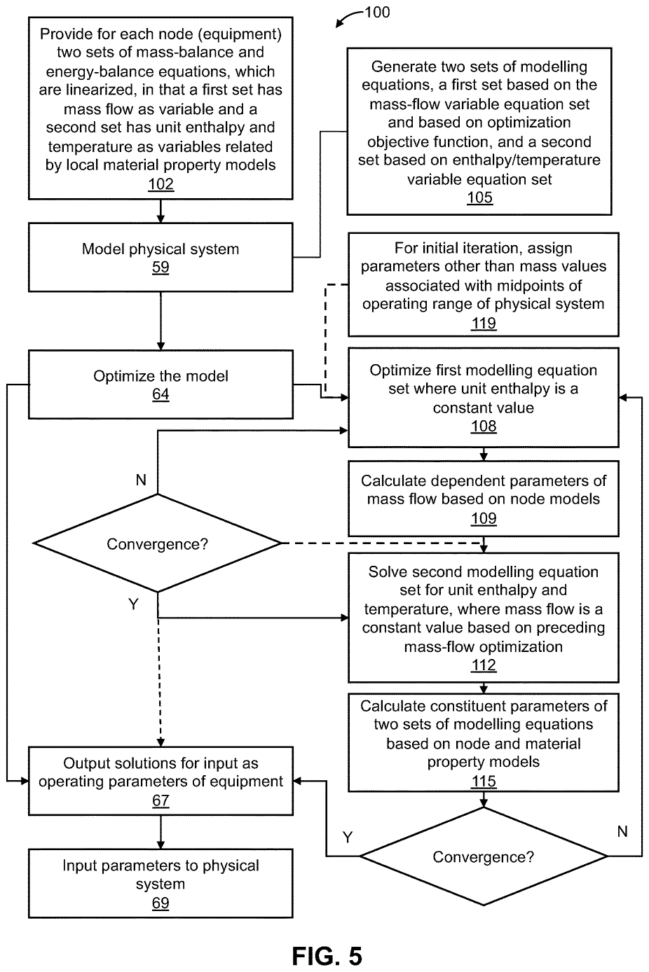

FIG. 5 illustrates a method 100 for optimizing a physical system, which is particularly suited for robust and rapid convergence.

At block 102, the modelling module 36 can provide, for each piece of equipment, a pair of sets of thermodynamic equations representative of operating behaviour of the piece of equipment at different levels of accuracy as to form a model of the equipment. These sets of thermodynamic equations include the fourth and fifth sets of mass-balance and energy-balance equations as previously defined.

At block 59, the modelling module 36 can model the physical system. More specifically, modelling, by the modelling module 36, is performed based on a representation of the physical system, which comprises nodes representative of the pieces of equipment and streams interconnecting the nodes and respectively representative of transfer of at least one of matter and energy from one piece of equipment towards another. Each stream is represented by component mass flows and bulk thermodynamic properties of material transferred within the stream expressed per unit mass or by energy flow. For example, the representation of the physical system is in the form of a topology based on a process flow diagram of the physical system.

Further, as at block 105, modelling, by the modelling module 36, in the method 100 can comprise generating a first set of modelling equations based on a first of the pair of sets of thermodynamic equations for all the nodes in the representation and the optimization objective function, which, in this case corresponds to the fourth mass-balance/energy-balance equation set. Additionally, still referring to block 105, the modelling step can comprise generating a second set of modelling equations based on a second of the pair of sets of thermodynamic equations for all the nodes in the representation, which, in this case corresponds to the fifth mass-balance/energy-balance equation set.

Then, at block 64, the optimizing module 38 can optimize the model of the physical system with respect to an optimization objective function, provided by the user and subsequently generated by the modelling module 36. More specifically, as at blocks 108 through 115, optimizing the physical system model can include iteratively, until a convergence condition is met, (i) optimizing the first set of modelling equations, where unity enthalpy is set to a prescribed enthalpy value as to be a constant; (ii) calculating, based on non-linearized node model equations, dependent parameters on mass flow using the mass flow computed from optimization of the first set of modelling equations of a corresponding iteration; (iii) solving the second set of modelling equations for unit enthalpy, temperature and pressure, where mass flow is set to a prescribed mass flow value based on optimization of the first set of modelling equations of the corresponding iteration (typically, at block 112, the prescribed mass flow value is that computed at block 108); and (iv) calculating constituent parameters of the first and second sets of modelling equations based on non-linearized node model equations and material property models (encompassing local and rigorous) and on solutions of the first and second sets of modelling equations of the corresponding iteration, which are usable in a subsequent iteration (of optimization). Preferably, the material property models used at block 115 are local material property models which expedite computation. In subsequent iterations, meaning, any iteration after the initial one, the prescribed enthalpy value used at block 108 is based on solution of the second set of modelling equations of a (immediately) preceding iteration, and generally is the unit enthalpy computed at block 112 of the previous iteration. Typically, the convergence condition is a difference between mass flow and/or unit enthalpy or temperature values from the latest pair of iterations.

At block 67, the output module 40 can output solutions determined by optimization of the model of the physical system representing operating parameters of the pieces of equipment, for input to the physical system to effect actual operating behaviour thereof.

In some cases, as at block 69, the output module 36 can pass and input the solutions of optimization to the physical system.

In some cases, the optimization module 38 can check for convergence in subsequent iterations, meaning, any iteration after the initial one, after blocks 108 and 109. In such cases, if the convergence condition (with respect to mass flow) is not met, that is, the difference between mass flows of the instant and preceding iterations is not within a prescribed threshold, then the optimization module 38 can return to block 108. However, if the convergence condition is determined to be met, then the optimization module 38 can continue to block 112. In some cases, if the convergence condition is determined to be met with respect to mass flow in a subsequent iteration, the output module 40 can output the solutions of optimization as at block 67, particularly if the user does not desire to have more accurate energy balances or material properties (which would be derived from solution of the second modelling equation set). In such cases, the convergence condition comprises a mass flow convergence condition, which is evaluated after optimizing the first modelling equation set, and an energy flow convergence condition, which is evaluated after solving the second modelling equation set. The energy flow convergence condition can be based on unit enthalpy or temperature.

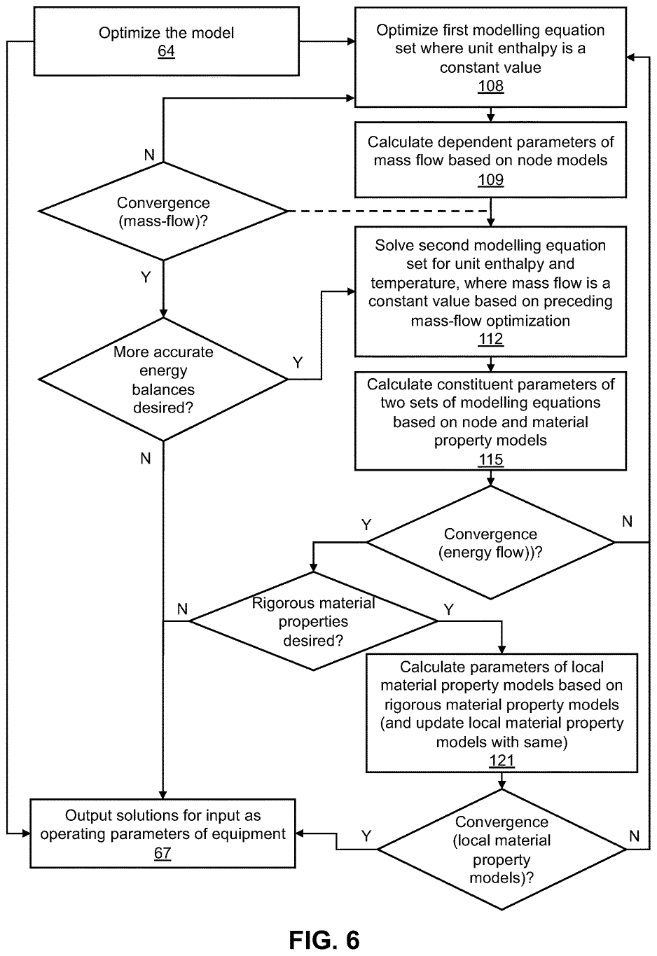

In some cases, checking for convergence may comprise, after determining that both the first and second modelling equation sets have converged, checking the local material property models for convergence based on values computed from rigorous material property models and that are based on the solutions of the first and second sets of modelling equations. If the convergence condition is met, then the output module 40 can output the solutions, including the rigorous material properties. If the convergence condition is not met, then the optimization module can return to block 108, with the local material property models updated to reflect the values computed from the rigorous material property models for a next iteration. This is more clearly shown in FIG. 6 including block 121.

When the mass and energy balance equation of at least one of the nodes contains parameters other than mass flow, the optimization module 34 can assign, before optimizing the first modelling equation set for all the nodes in an initial iteration, the other parameters values associated with normal operating conditions of the physical system, as at block 119. As such, the prescribed unit enthalpy value in the initial iteration of optimization is that at the normal operating conditions (NOC).

In some cases, the optimization module 38 can calculate the constituent parameters at block 115 by calculating mass flow, pressure and temperature solely based on the non-linearized node model equations and calculating parameters other than mass flow, pressure, and temperature (for example, unit enthalpy) solely based on local material property models. In such cases, checking for convergence after blocks 112 and 115 can comprise checking if parameters of the local material property models have converged. Preferably, when convergence of local material property models is checked, the optimization module 38 can calculate (as part of checking for convergence, after block 115) the parameters of the local property models based on rigorous material property models and update the local material property models based on these calculations.

Thus is provided an arrangement for optimizing a physical system normally modelled by nonlinear systems of equations, which contain thousands of bilinear terms corresponding to mass flow-(unit) enthalpy terms (encountered in mass and energy balance equations), with rapid and robust convergence.

As described hereinbefore, the present invention relates to methods and related systems for optimizing a physical system having interconnected pieces of equipment, between which matter and energy flow. In an aspect, the method comprises representing the physical system as a topology of nodes representing the equipment and streams representing transfer of matter/energy from one equipment towards another, where each node can instantiate multiple sets of thermodynamic equations representative of equipment operating behaviour at different levels of accuracy. The method includes modelling the physical system by generating sets of modelling equations based on selected node model equations (based on desired model accuracy determined by the selected abstraction level) and an optimization objective function. In another aspect, the method comprises modelling based on a first set of linearized node model mass-balance and energy-balance equations, in which mass flow is a variable and unit enthalpy is provided as a constant, and on a second linearized node model mass-balance and energy-balance equation set, in which unit enthalpy, temperature and pressure are variables related by local property models, and the method further comprises optimizing this model.

In other words, it is proposed that the process flow diagram containing all equipment in the plant is the unified representation of the plant, informally referred to herein as “mother of all plant models”. Plant models of different abstraction levels are then instantiated by employing different levels of stream and node abstractions. It is proposed that models employing mass component flows, stream enthalpy at the local stream conditions, and local approximations of bulk stream properties, are used to model process flowsheets instead of molar flows, fractions, and rigorous property calculations at each flowsheet iteration. This turns material, energy, and composition equations of a process flowsheet into a linear model if the node models are linear. For streams that may have two phases, it is initially assumed that the vapor fraction remains constant even though optimization algorithms may change stream flows or temperatures. After the model with local material property models calculations has converged, bulk stream properties (including vapor fractions) are updated from rigorous calculations and the flowsheet model is resolved until convergence with respect to rigorous material properties update is achieved via updating local material property models.

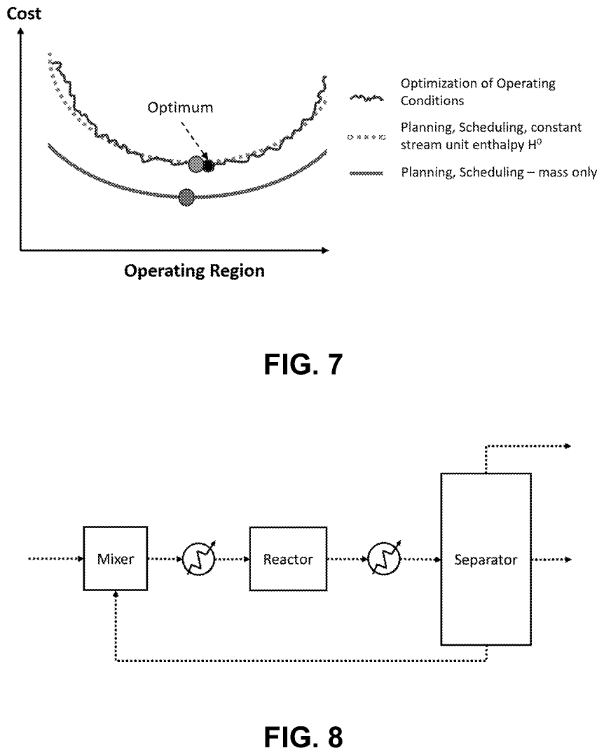

Optimization of plant models at different abstraction levels leads to solutions which are in some proximity of the true optimum; the distance from the true optimum depends on the level of model abstraction. FIG. 7 represents conceptual minimization of operating costs of a hypothetical plant. Optimization based on mass balances only has the lowest cost since it does not account for energy costs. There are minimal computational cost increases to add energy balances at fixed stream unit enthalpies, and the optimum may lie at somewhat different point. However, inclusion of energy balances is closer to the vicinity of the true optimum, since the bulk material and energy costs determine the vicinity of the true optimum. By including local approximation of stream unit enthalpy (and other properties), the optimum solution is likely to change but not very far. An alternative is to update the stream local properties (e.g. heat capacity or unit enthalpy) after the plant model is solved and then resolve the model. This route preserves linearity of the overall plant model while adding a couple of iterations to converge on the local property models properties. Proceeding even further by including rigorous thermophysical property calculations may give some further accuracy. This step is appropriate if very accurate optimization of plant operating conditions or process design are carried out.

Please note that moving from coarser (mass balance only) to finer (mass and energy balances) abstractions results in solutions at a coarser level that can be used as initial points for the more detailed abstraction of the model. The unified modeling paradigm proposed herein enables such inheritance through construction of composite solution algorithms that successively solve the models that are based on the same plant topology.

In addition to plant models being instantiated at different levels of stream abstraction from one business application to another, different levels of stream abstraction for different sections of a flowsheet make them easier to solve and meet the business purpose for which the model is built. Similarly, node models can be instantiated at different levels of abstraction (e.g. material balance only, or material end energy balances).

It is proposed that process streams and material inventories be measured in mass units which is the measurement environment in the plants. This enables integration of hybrid equipment models without (to some extent error prone) conversion to moles and the use local material property models for plant wide optimization, scheduling, and integration with control.

The modelling paradigm disclosed herein may:
i) Eliminate nonlinearities associated with stream representations (mole fractions and associated rigorous properties calculations for each stream instance).
ii) Ensure consistency of solutions among different plant model abstractions.
iii) Enable use of any type (abstraction) of node models, e.g. linear or nonlinear, hybrid or first principles.

Various plant level abstractions and their use in decision making processes are described hereinafter, with examples showing that uniform plant level abstraction is not appropriate and instantiating different parts of a plant at different levels of abstraction may provide better results. Also described herein is a concept of changing stream and material representation for total molar flow and mole fractions (“moles & fractions” paradigm) to mass component flow (“mass & flows” paradigm), which enables development of hybrid process unit models that are linear or less nonlinear than mole fraction-based unit models (e.g. reactors), as well as eliminating a significant number of bilinear terms. Also described herein is computation of energy balances based on unit enthalpy per mass instead of unit enthalpy per mole since the former is less sensitive to changes in stream composition. Energy balances computed from unit enthalpies per mass at normal operating conditions of streams are introduced (i.e. temperature is fixed at), which leads to a linear mass and energy balances (if node models are linear). Such solutions are in the vicinity of the optimum so long as the plant operates in the normal operating region. Using mass instead of moles makes it possible to use local approximations of the bulk physical properties and still have accuracy close to rigorous property calculations. Stream properties at normal operating conditions (unit enthalpy, heat capacity, vapor fraction, etc.) are calculated in advance via rigorous thermodynamic methods. Calculation of properties at local stream conditions is best carried out via rigorous plant model which includes unit models and streams to accurately model the. Such model most of the time does not correspond exactly to the plant flow diagram and it certainly cannot be used for planning or scheduling (the model is highly nonlinear and cannot be solved as a part of e.g. 12 time period planning model). The property values computed via rigorous model are used as a base for local approximation if stream temperatures deviate from normal operating conditions. This avoids stream flash calculations for every stream and eliminates many nonlinear terms from the plant model.

The present inventors propose switching from moles to mass units because doing so enhances accuracy of local material property models.

Equations (1) to (17) compare total molar flow & fractions paradigm & to total mass flow and mass flows of components paradigm.

Fraction-based mixing model represented by Eq. (1) to (4) contains NIN*NC (eq. 1) plus NC bilinear terms (eq. 4).

$${F}_{i} {x}_{i , j} - {F}_{i , j} = 0 i = 1 , … , NIN ; j = 1 , … , NC \qquad ( 1 )$$

$${\sum }_{i = 1}^{NIN} {F}_{i , j} - {F}_{out , j} = 0 \qquad ( 2 )$$

$${\sum }_{j = 1}^{NC} {F}_{out , j} - {F}_{out} = 0 \qquad ( 3 )$$

$${F}_{out} {x}_{out , j} - {F}_{out , j} = 0 \qquad ( 4 )$$

Flow-based mixing model represented by eqs. (5) to (7) contains NC bilinear terms (eq. 7), which is NC×NIN less than Eq. (1) to (4).

$${\sum }_{i = 1}^{NIN} {F}_{i , j} - {F}_{out , j} = 0 \qquad ( 5 )$$

$${\sum }_{j = 1}^{NC} {F}_{out , j} - {F}_{out} = 0 \qquad ( 6 )$$

$${F}_{out} {x}_{out , j} - {F}_{out , j} \qquad ( 7 )$$

If a stream is divided into several (NOUT) flows, that is described by equations (7) and (8), which hold for both (total flow, fractions) and for (component flows, fractions) paradigms. Please note that in the (component flows, fractions) paradigm, the inlet stream to a flow splitter is described by both component flows and by fractions.

$${F}_{in} - {\sum }_{k = 0}^{NOUT} {F}_{k} = 0 \qquad ( 7 a )$$

$${x}_{in , j} - {x}_{k , j} = 0 j = 1 , … , NC ; k = 1 , … , NOUT \qquad ( 8 )$$

Equation (7) assumes that the outlet flows are determined from some downstream demands. Eq. (9) is added if split fractions αₖ of the inlet stream into outlets is predefined.

$${F}_{in} {α}_{k} - {F}_{k} = 0 k = 1 , … , NOUT \qquad ( 9 )$$

Component separator produces streams that each may have composition different from the feed stream.

Fraction-based separator model is described by Eq. (10) to 13). It contains NC bilinear terms (eq. 10) plus NC×NOUT bilinear terms (eq. 13),

$${F}_{in} {x}_{in , j} - {F}_{in , j} = 0 j = 1 , … , NC \qquad ( 10 )$$

$${F}_{in , j} {α}_{k , j} - {F}_{k , j} = 0 j = 1 , … , NC ; k = 1 , … , NOUT \qquad ( 11 )$$

$${\sum }_{J = 1}^{NC} {F}_{k , j} - {F}_{k} = 0 k = 1 , … , NOUT \qquad ( 12 )$$

$${F}_{k} {x}_{k , j} - {F}_{k , j} = 0 j = 1 , … , NC ; k = 1 , … , NOUT \qquad ( 13 )$$

Flow-based component separator model is described by Eq. (14) and (15). It does not contain any bilinear terms, which is NC×(1+NOUT) less than fractions-based separator model.

$${F}_{in , j} {α}_{k , j} - {F}_{k , j} = 0 j = 1 , … , NC ; k = 1 , … , NOUT \qquad ( 14 )$$

$${\sum }_{j = 1}^{NC} {F}_{k j} - {F}_{k} = 0 k = 1 , … , NOUT \qquad ( 15 )$$

Without generalization, two examples of chemical reactors represented by linear models when using component mass flows are described. Both reactors, autothermal reforming (ATR) of methane to produce hydrogen and water-gas shift (WGS) reactor, are modelled well by RGibbs reactor in AspenPlus.

Production of hydrogen in ATR is represented accurately by Eq. (16), where x are mass fractions of components in the reactor feed and y_H is mass fraction of hydrogen at the exit, while T[K] is the reactor temperature.

$${\sum }_{j = 1}^{NC} {a}_{j} {x}_{j} + {a}_{y} {y}_{H} + {a}_{T} T = 0 \qquad ( 16 )$$

Since mass flow of the feed F_{feed} to the reactor is equal to the mass flow of products leaving the reactor (which is not the case if amounts are expressed in moles), one can multiple Eq. 16 by feed mass flow to obtain:

$${\sum }_{j = 1}^{NC} {a}_{j} {F}_{j} + {a}_{y} {F}_{H} + {a}_{T} {F}_{feed} T = 0 \qquad ( 17 )$$

The reactor temperature is kept at the highest possible temperature, i.e. reactor temperature T_ATR is constant. Hence, the model of ATR is linear when component mass flows are used. That is not possible if moles & fractions model is used. Similarly, WGS reactor model is also linear when component flows are used. Even if T is not constant there is only one bilinear term.

Energy balance models in all versions of plant models can permit CO2 emissions and time-of-use energy pricing to be considered.

Calculation of very accurate energy balances involves knowledge of stream temperatures, rigorous heat exchanger network models, as well as energy consumption/production by different process equipment. However, it is possible to compute accurate energy balances as long as the process streams are at their typical operating conditions and then improve the accuracy by iterative calculation as shown below. For given feed composition, most of the time streams leaving process units are at specified pressure, temperature and composition that tends to remain substantially constant. The present inventors propose that accurate energy balances can be calculated by using enthalpy per unit mass and heat of vaporization per unit mass at typical conditions of each stream (H0) and by using, and heat of reaction per unit mass at typical conditions for reactors.

A prototypical chemical plant is comprised of a feed system, reactor, separator, and a recycle of unreacted reactants (FIG. 8). Assuming that under given temperature T⁰ and pressure P⁰ of each stream s, unit enthalpy H⁰ [energy/mass] can be calculated (e.g. from a rigorous thermophysical properties software or from a rigorous plant model). Mass is used instead of moles for the following reasons.

Thermal properties (heat capacity, heat of vaporization) expressed as [energy/mass] are less sensitive to changes in composition expressed in mass units than in moles. This is illustrated in Table 1.

TABLE 1
Change of latent heat of vaporization and heat
capacity for C₅H₁₀ to C₁₀H₂₂ paraffins.

| | Latent Heat of Vaporization | | | | Heat capacity at 25 deg C. | | | |
|---|---|---|---|---|---|---|---|---|
| | kJ/kg | delta, % | kJ/mole | delta, % | kJ/kg/K | delta, % | kJ/mole/K | delta, % |
| C₅H₁₀ | 377.43 | | 26.42 | | 2.409 | | 0.169 | |
| C₆H₁₂ | 367.86 | −3% | 30.90 | 17% | 2.353 | −2% | 0.198 | 17% |
| C₇H₁₆ | 362.00 | −2% | 36.20 | 17% | 2.247 | −4% | 0.225 | 14% |
| C₈H₁₈ | 364.56 | 1% | 41.56 | 15% | 2.243 | 0% | 0.256 | 14% |
| C₉H₂₀ | 362.50 | −1% | 46.40 | 12% | 2.225 | −1% | 0.285 | 11% |
| C₁₀H₂₂ | 362.11 | 0% | 51.42 | 11% | 2.218 | 0% | 0.315 | 11% |

The present inventors propose to write plant energy balance for any node n as follows:

$${\sum }_{i = 1}^{NIN} {F}_{i , n} {H}_{i}^{0} + {Q}_{in , n} + {Q}_{rct , n} - {\sum }_{k = 1}^{NOUT} {F}_{k , n} {H}_{k}^{0} + {Q}_{out , n} = 0 \qquad ( 18 )$$

where Q_(in,n) and Q_(out,n) is energy added or removed to/from the unit, Q_(rct,n) is heat of reaction if there is a reaction in the unit, and H⁰ is the unit enthalpy at normal operating conditions. Note that (18) calculates accurately energy balances at any feed rate, as long as states of the process streams remain at normal operating conditions.

Such energy balance model corresponds to typical plant conditions. As long as the changes in the plant are due to changes in flows, these energy balance models are as accurate as the models built on rigorous first principles equations. Hence, using this kind of energy balance in production planning or plant scheduling enables accurate optimization with respect to time of use energy pricing without introducing nonlinearities.

If process unit models represent the impact of operating variables (e.g. conversion in a reactor or different modes of operation), then mass balance models (Eq. 1 to 17) and energy balance models (Eq. 18) for each node enable optimization of plant throughput and its operating conditions without introduction of plant-level nonlinearities caused by fractions and moles stream abstraction. These types of models optimize production plans and schedules of plants that consume significant amounts of energy, particularly if energy prices change frequently (e.g. electricity supplied to a blue hydrogen autothermal reforming plant). For most production planning and scheduling decision making, models represented by Eq. (1)-(18) account sufficiently accurately for energy consumption and production. Such models are appropriate energy intensive processes, e.g. blue hydrogen plan equipped with a combined heat and power unit (CHP) which produces electricity for oxygen production via air separation and for hydrogen liquefaction, and possibly exporting electricity to the grid. Grid electricity prices often change every 10 to 15 minutes, which means that the optimal operations over the next several time periods are calculated within seconds and then promptly implemented in the plant.

Optimization of operating conditions may lead to changes of temperatures of the streams leaving some process units. Such changes are limited in magnitude since the process unit (e.g. reactor) is still expected to produce the same product, albeit with some variations in product composition or some of the product properties. If the changes in the temperatures of the outlet streams are very large (e.g. 50 K or 100 K), it can be argued that the process unit is either no longer functioning properly or that it operates in a different operating mode; the latter case can then be modelled by two models, one for each mode of operation).

Since changes in the stream temperatures are limited, at constant pressure, unit enthalpy for each stream can be updated by:

$${H}_{k} = {H}_{k}^{0} + {C}_{p} ( {T}_{k} - {T}_{k}^{0} ) \qquad ( 19 )$$

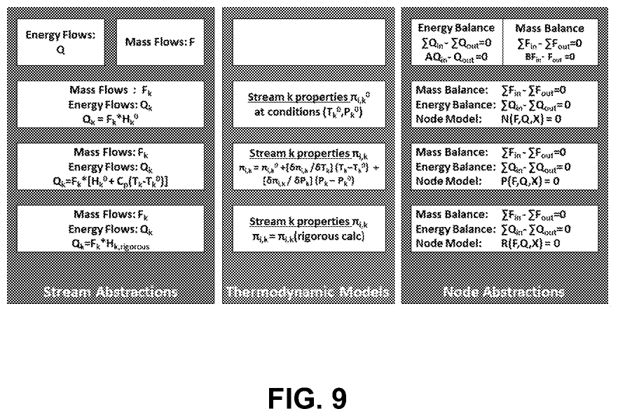

FIG. 9 depicts the node and stream abstraction levels, depending on calculation of stream unit enthalpy.

Solution of mass balance and energy balance with fixed stream unit enthalpies, Eqs. (1) to (18), does not consider changes in temperatures of the streams which may occur if there are heat recovery exchangers in the plant. If stream temperature changes due to presence of heat exchangers are included in the model:
1. Determine the flows through the network via mass balance set of equations—Eq. (1) to Eq. (17) and energy balances with fixed stream unit enthalpies, Eq. (18). Note that the nonlinear terms will appear only in stream dividers and possibly in reactor models.
2. For each heat exchanger, calculate heat exchanger duty ratio φ relative to the exchanger duty Q_base at some known conditions. This ratio depends only on the flows through the exchanger and the conditions corresponding to the base duty.
3. For each exchanger, the duty corresponding to the flows calculated by (1)-(17) is then given by Eq. (20)

$${Q}_{n} = {ϕ}_{n} {Q}_{base} ( {T}_{hot , n}^{in} - {T}_{cold , n}^{in} ) \qquad ( 20 )$$

4. The next step is to solve energy balance equations (20), and (21) to compute the stream temperatures from energy balances for hot and cold streams of each exchanger and energy balances for the remainder of the nodes in the plant model. Note that Eq. (21) and (22) are liner equations since exchanger duty and flows are known at this point.

$${Q}_{hot , n} = {F}_{hot , n} {H}_{hot , n}^{0 , in} + {Cp}_{hot , n} [ ( {T}_{hot , n}^{in} - {T}_{hot , n}^{0 , in} ) - ( {T}_{hot , n}^{out} - {T}_{hot , n}^{0 , out} ) ] \qquad ( 21 )$$

$${Q}_{cold , n} = {F}_{cold , n} {H}_{cold , n}^{0 , in} + {Cp}_{cold , n} [ ( {T}_{cold , n}^{in} - {T}_{cold , n}^{0 , in} ) - ( {T}_{cold , n}^{out} - {T}_{cold , n}^{0 , out} ) ] \qquad ( 22 )$$

5. The new value of the stream temperatures can now be used to update stream unit enthalpies (from Eq. (19) or from rigorous thermodynamic calculations) and repeat the calculations from step 1 until changes of stream temperatures are within tolerance.

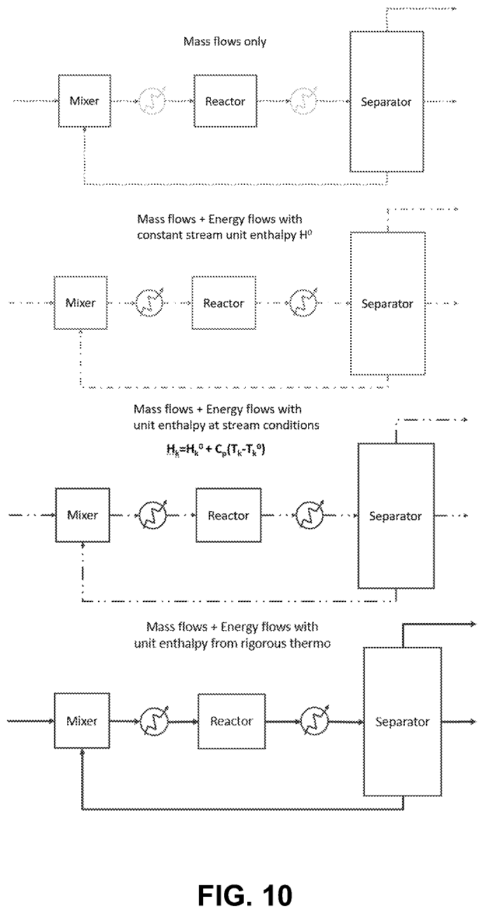

If all incarnations of plant models are instantiated from the same plant topology as illustrated in FIG. 10, then moving from one abstraction level to another means that the solution from a higher abstraction level is available as a starting point for a solution of the more detailed abstraction.

Please note that different incarnations of node models have different sets of equations. For instance, if the plant model incarnation is based on mass balances only, then a heat exchange model incarnation also has only mass balance equations, which are linear. That makes it possible e.g. to have a production planning model which includes heat exchanger nodes without affecting the solution times, since these nodes add only linear equations.

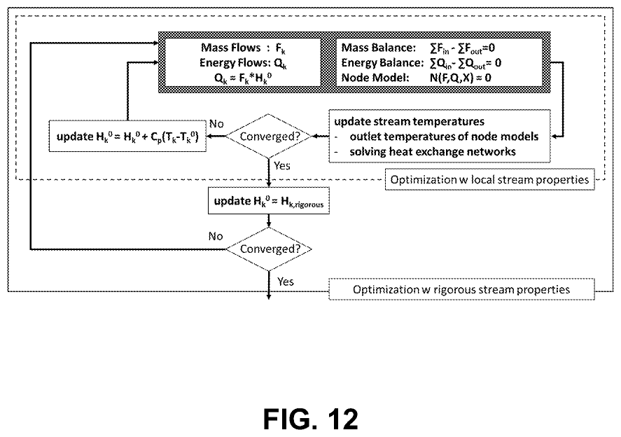

To have consistency across the life cycle, from process design to production planning, rigorous thermodynamic calculation of stream properties and first-principles equipment design models (node models) are included in one of the plant model incarnations. Solution algorithm that includes properties update via rigorous thermodynamic calculations as shown in FIG. 12. First principles equipment design models can be included in one of the following manners:

After the plant model with approximate node model is converged, update approximate (hybrid) node model from a rigorous model.

After the plant model with approximate node models is converged, use its results as an (excellent) starting point for solving the plant model that uses rigorous node models. These node models convert stream mass component flows to mole fractions.

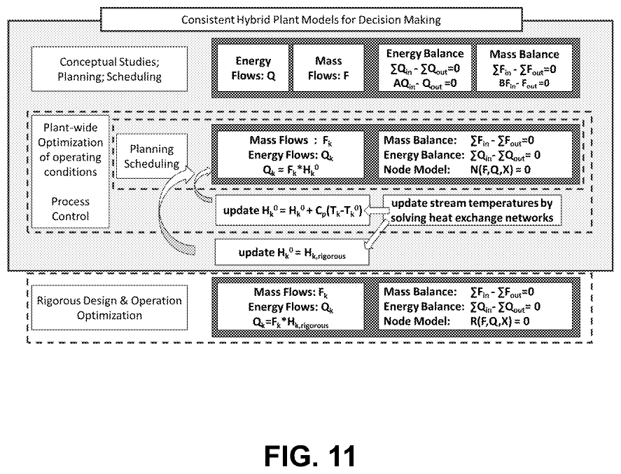

If all models for decision making in the plant are instantiated as different incarnations from the same plant topology, then solution from one decision-making step corresponds to the solution in another decision-making step, e.g. solution of a scheduling model, at some points along the scheduling horizon, corresponds to the planning solution along the same time horizon. FIG. 11 maps different abstraction levels to plant models for different decision-making processes.

The present inventors propose constructing algorithms that will approach the optimum in multiple steps instead of solving all model equations at once. The first big step is to optimize the plant model described by mass balances and energy balances described by the stream unit enthalpy (and other properties) at typical conditions of each stream. Solution of such a model will lead us to the proximity of the optimum. Such a solution is likely to be sufficiently accurate for production planning and scheduling (and it will be more accurate than the typical planning and scheduling models are today).

If process nodes change their outlet temperatures (e.g. the optimal solution may be to move a reactor to a different mode of operation, or the node is a heat exchanger without control of its outlet stream temperatures), the stream unit enthalpies can be updated to the new temperatures determined by the operation of each relevant node, as depicted by the dashed frame in FIG. 12.

If local updates of stream properties are not sufficiently accurate, an outer loop can be added, where the stream properties are updated from rigorous thermophysical properties calculations.

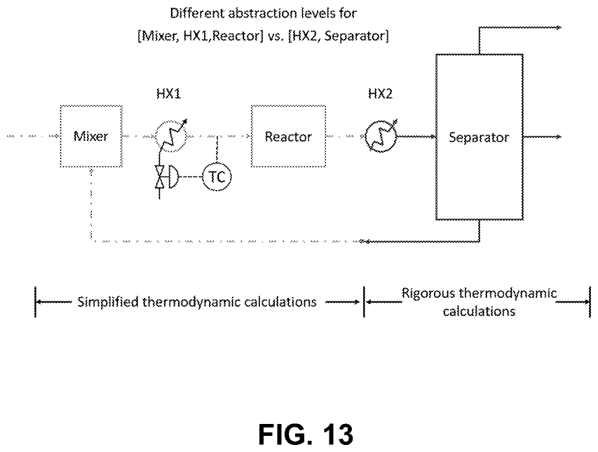

The present inventors propose that plant models be instantiated at the level of abstraction that meets the demands of the business processes that will use the model to make decisions. Further, it is proposed that each flowsheet node, corresponding to a specific equipment, is able to generate model equations which correspond to the level of abstraction for specific decision making. Different parts of the plant can be modelled at different levels of detail. For instance, to achieve the desired level of accuracy, a heat exchanger and a separator may be modelled by rigorous first principles models, while the remainder of the plant may be modelled by hybrid node models and stream enthalpies at normal operating conditions, as illustrated in FIG. 13.

The ability to model different sections of a plant and in different time periods at different abstraction levels creates a possibility to approach solving some vexing business issues in a novel manner, as illustrated below.

Most real-time optimization (RTO) applications consider plant operation at a given point in time, which can lead to RTO making decisions that are not optimal over some time horizon, e.g. over the next shift or the next couple of days. RTO based on rigorous first principles models is hampered by the sheer size and the nonlinearities of these models.

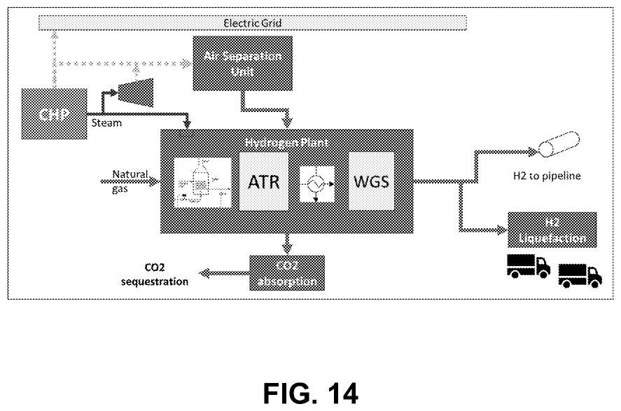

Consider a hydrogen plant which produces hydrogen from natural gas via autothermal reforming (ATR) and water gas shift (WGS) reactors. Hydrogen product is sent to a pipeline and also shipped via trucks to local consumption. A simplified representation of the plant is shown in FIG. 14.

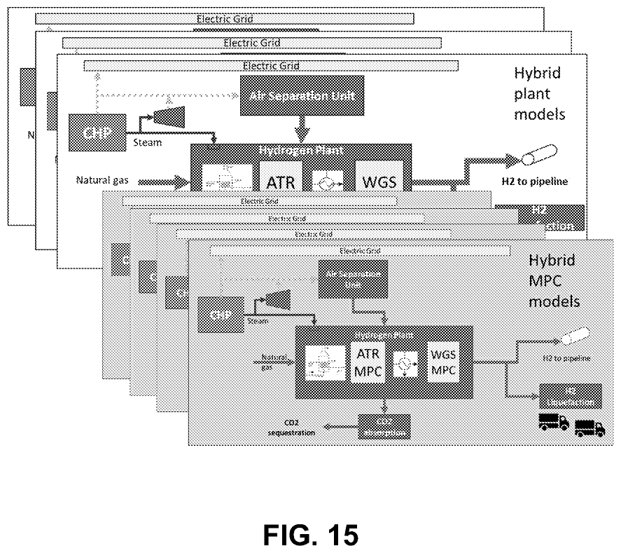

Since electricity prices change frequently (e.g. every 15 minutes), the real-time optimization of the plant operation considers operation over a time horizon that may span the time for the material to flow through the plant (e.g. 1 hr), instead of just a point in time, which leads to a model of with at least 4 periods. To avoid a mismatch between RTO and the control model, the plant models for the first 4 periods can be implemented as hybrid models comprised of MPC model augmented by mass and energy balances (see FIG. 15), while subsequent periods may use steady-state hybrid models. If the plant models are described by component mass flows, energy balances, and reactor models as described above, the six time-period model will have only a handful of bilinear terms, which will provide robust, rapid convergence. If stream temperatures change as a result of optimization, then a composite algorithm as described herein can be used to optimize the entire multi-period model.

The proposed approach is a scalable alternative to dynamic RTO, and it is suitable for dynamic real time optimization of entire plants.

Scheduling of process plant operation has been approached via discrete-time models and continuous-time models. While discrete-time models are not as precise as continuous-time models, they provide faster computations of schedules for process plants. In industrial practice, scheduling has been more widely applied in batch plants, while in multi-product continuous plants (e.g. petroleum refineries) scheduling is still done by verifying heuristic schedules via simulation.

Since scheduling models include binary variables, the plant is represented by a linear model to achieve acceptable computation times. Plant models based on component mass flows and unit enthalpy fixed at local stream conditions, together with linearized representation of reactors and separation units, are more accurate than the scheduling models of the current state of the art, and if they are implemented in the proposed paradigm, then the scheduling models inherit solutions from the longer-term production planning models.

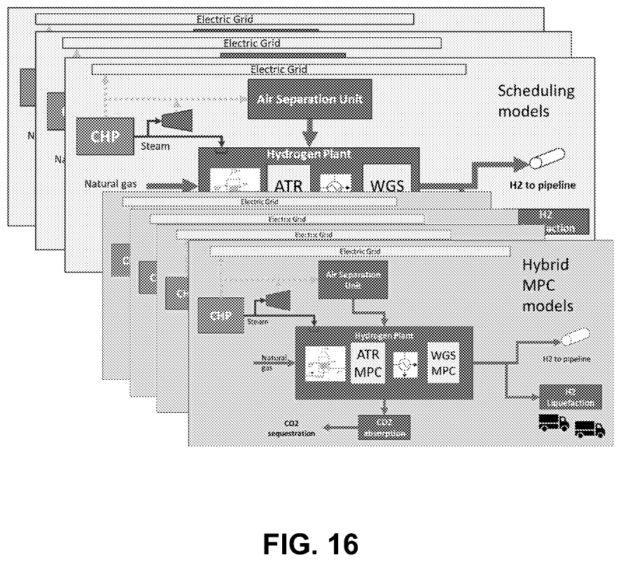

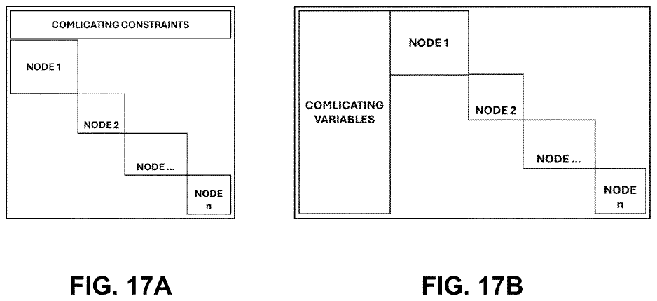

It is proposed that the scheduling and control can be integrated via a multi-period model, where in the initial periods the plant is modelled by hybrid MPC models (models comprised of mass and energy balances and of MPC process models), while the later periods are scheduling models as described above (FIG. 16).

Plant model incarnations from the same process topology ensures consistency among various plant models. The proposed paradigm enables solutions from one level of abstraction to be consistent with solutions at another level of abstraction, i.e. from one business process to another. It makes both first principles and hybrid models (part first principles, part empirical) a natural fit to the plant modelling environment.

Switching from (mole & fractions, rigorous properties) to (mass component flows, properties at the standard stream conditions) enables comparable level of accuracy while eliminating nonlinearities associated with stream state calculations. Mass-based physical properties are less sensitive to changes in composition than mole-based physical properties. This makes it possible to build planning and scheduling models that are linear (with respect to stream representation) and yet as accurate as the rigorous models at the typical plant operating conditions. Local approximations of physical properties at the stream conditions are best derived by first building a rigorous plant model and using it as a source of data for physical property approximations for each stream. That ensures accuracy of different plant model incarnations at the. Rigorous, first principles plant model remains as a foundation that enables building of approximate models of different levels of abstraction, until at the final, deepest level, the abstraction is the rigorous model itself.

Different incarnations of a plant model, based on the same plant topology ensure consistency of material balances from one incarnation to another, while energy balances become increasingly accurate as increasingly accurate representation of physical properties are employed. Such a framework will enable development of more accurate (e.g. mass and energy balance models) and faster converging models for planning, scheduling, and plant optimization, while leveraging effort put forth to build one incarnation of the plant model to create another, different incarnation of the plant model.

Different node model abstraction levels, in different sections of a plant model and in different periods, open gates to new approaches to optimal planning, scheduling, RTO, and control, and to their integration and ensuring consistency of solutions between them.

As disclosed herein, the present inventors propose a process for unified digital twin plant models, employing stream component mass flows at fixed unit enthalpy, for consistent integration of control, scheduling, operating conditions optimization, and production planning.

The present inventors propose consistency between all versions of the plant models is attained by instantiating all versions of the models from the same topological (network) representation of the plant.

The present inventors propose that all process plant models are instantiated from the same plant network representation embodied in a detailed plant flow diagram (PFD).

The present inventors propose that the same process streams appear in all versions of process models (design model, operations optimization model, control model, scheduling model, planning model).

The present inventors propose that different versions of the plant models are created by instantiating models of different abstraction levels (e.g. mass balance only, or energy balance only, or mass and energy balances, etc.) for each node. Models at higher abstraction are augmented by additional equations and variables when creating model version at the lower abstraction level (more detailed models). The variables and equations from the higher abstraction level are retained at the lower abstraction level (more detailed model).

This ensures that the results from plant models at one level of abstraction (e.g. scheduling model) are consistent with the results from plant models at another level of abstraction (e.g. real-time optimization model).

The present inventors propose a new way to formulate accurate energy balances in while retaining linear model structure and rapid convergence enables accurate computation of energy consumption and CO2 emissions in all versions of plant models.

All versions of plant models calculate mass and energy balances by describing
Mass balance equations expressed by
   mass flow of each component and by the total flow of each stream.
Energy balance expressed by
   mass flow of a stream] multiplied by [enthalpy per unit mass at normal operating conditions—stream temperature and pressure].
Process equipment models (node models) representing normal operating range by linear mass and energy balances.

This makes it possible for multi-period scheduling and planning models to compute energy demands and still solve very quickly since equations are linear.

The present inventors propose a composite algorithm for solving/optimizing plant models.

More specifically, the present inventors propose to simulate operation or optimize operation of process plants by:
1. Solving the plant model comprised of linear set of mass and energy balance equations that employ equations described in hereinbefore.
2. Solve energy balance equations, where:
   a. Mass flows are set to the value computed in step 1. above.
   b. Heat exchangers are described by linear equations that enable computation of heat exchanger outlet temperatures.
3. Update the stream unit enthalpies and other properties to the new temperatures computed in step 2 above. Unit enthalpy update can be from local material property models or from rigorous thermodynamic models.
4. Repeat the steps 1, 2 and 3 until the update of the updates of unit enthalpies are smaller than the specified tolerance.

If stream update in step 3 are from local material property models, linear models, then the enthalpy update equations can be included as part of the node model equations. That makes the equations solved in step 1 and step 2 linear, which ensures rapid convergence of multi-period models generated from these equations. Such multi-period models, when used for multi-period production planning optimization and for optimization of discrete-time scheduling models, provide a new level of accuracy to planning and scheduling decisions, since they include accurate energy balances.

If stream enthalpy updates in step 3 are from local material property models, then the solution accuracy can be further increased by adding steps 5 and 6 as described below:
5. Update local material property models models from rigorous properties calculations.
6. Repeat the steps 1. to 4. until the update of the updates of local material property models are smaller than the specified tolerance.

The present inventors propose that model accuracy in different time-periods is selected to correspond to the accuracy of the data for that period, while still representing the plant by the same topography to attain rapid computation and appropriate accuracy.

Multiperiod models, e.g. models for optimal real time control and optimization, or for scheduling, or for planning, can use different levels of node models or of process units (process subnetworks) abstraction in different periods. This makes it possible to use more accurate node models in earlier periods, when accuracy of the cost data or of the product demands is higher. In the later periods, when accuracy of the cost data or of the product demands is lower, the plant model can use less accurate models to match the accuracy of the data.

This makes it possible to solve many-periods models very rapidly, while ensuring that accuracy of the model solutions corresponds to the accuracy of data available for the corresponding time periods.

The present inventors propose elimination of discrepancies between solutions to decisions that correspond to different time frames (control, RTO, scheduling, planning).

Ability to use different versions of node models in different periods makes it possible to integrate solutions of different decision making, i.e. solve simultaneously.

Model predictive control (MPC) models, integrated in the nearest time periods (e.g. 1st, 2nd, and further time-periods) within node or subnetwork models, represent dynamic plant behaviour and provide optimal solution for real-time optimization. The number of time-periods is such that they together cover the length of time for the plant to reach steady state.

Periods covering process control and RTO are described above. Periods beyond the time for the plant to reach steady-state are represented by steady-state material and energy balances. The node models in the periods corresponding to the scheduling horizon include scheduling constraints. They cover the time until the end of the scheduling horizon.

Time periods corresponding to the scheduling horizon include versions of node models that incorporate scheduling constraints. The versions of the node models corresponding to the planning periods do not include the scheduling constraints.

The present inventors propose a unified digital twin plant model, employing stream component mass flows at fixed unit enthalpy, for consistent integration of control, scheduling, operating conditions optimization, and production planning.

The present inventors propose a method for a unified digital twin plant model, where consistency between all versions of the plant model is attained by instantiating all versions of the model from the same topological network representation of the plant.

The present inventors propose a method for a unified digital twin plant models, where the model includes composite algorithms for solving and optimizing the model.

The present inventors propose a method for a unified digital twin plant models, where the model accuracy in different time-periods is selected to correspond to the accuracy of the data for that period while still representing the plant by the same topography to attain rapid computation and appropriate accuracy.

The present inventors propose a method for a unified digital twin plant models, where the model includes the elimination of discrepancies between solutions to decisions that correspond to different time frames.

As described hereinbefore, in an aspect, the present invention relates to plant modelling paradigms and how to change them to a different unified paradigm which attains accuracy on par with the rigorous plant modelling while eliminating many plant-level nonlinearities that appear in the rigorous modelling paradigm.

In other words, as described hereinbefore, in an aspect, the present invention relates to changing the plant modeling paradigm to achieve much easier convergence and ensure model consistency between different incarnations of the plant model, while retaining accuracy on par with the rigorous models. Rigorous physical properties [property/mole] are replaced by [property/mass] approximation at local conditions, making bulk properties much less sensitive to changes in stream composition. This eliminates stream mole fractions, and stream compositions can be described by linear component mass flows. Detailed process flow diagrams are common topology for all models. Different incarnations of node models are employed at different levels of abstraction (planning, scheduling, optimization, control, design), ensuring inheritance, consistency and increasing accuracy of solutions as plant model instances move from mass to mass-energy, to mass-energy-and-approximate-stream-properties. After the plant model with approximate properties is solved, they are updated via rigorous thermodynamic methods and the plant model is resolved until convergence.

Additionally, the present inventors propose to partition model variables and equations into ordered blocks, each of them representing an increasing level of model accuracy, instead of solving all model equations simultaneously. Different levels of model accuracy (model abstraction) correspond to the model accuracy for specific business applications, e.g., production planning, scheduling, optimization of operating conditions or design variables. The selected set of equations is solved by a fixed-point block iterative procedure.

This disclosure describes solutions of plant model abstraction corresponding to the hybrid models that can be used for production planning, scheduling, or real-time optimization. The equations are partitioned into two sets. The first set is comprised of linear mass balances and approximate energy balances; the second set is accurate linear energy balance equations at given values of flows. The composite algorithm solves in Phase I the first set of equations, which (if desired) is followed by nonlinear computations that update parameters of the model equations used in the subsequent phase. Phase II solves the second set of equations, which again is followed by updating the parameters of the model equations used in Phase I. Since equations in both Phase I and Phase II are linear, large accurate multi-period models are solved very rapidly.

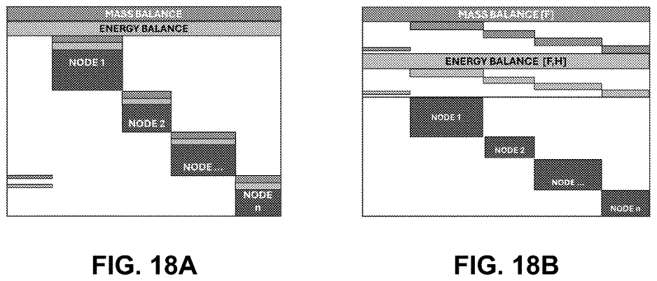

Consider the entire set of equations describing a rigorous plant model, as depicted in FIG. 18A. In principle, the model embodying these equations could be used for all decision making, e.g., production planning, scheduling, optimization of operating conditions, dynamic optimization, etc. In practice, this is not possible since, e.g., multiperiod nonlinear planning models would comprise hundreds of thousands of nonlinear equations that could not be solved within acceptable execution times.

As shown in FIG. 18B, one can partition the plant model equations so that material balances (light blue blocks) and energy balances (orange blocks) are collected into one subset of equations, while the remaining equations of each node model constitute separate blocks of equations (dark blue), as shown in FIG. 18B. If parameters of material and energy balance equations are known, these can be solved by themselves, instead of solving the entire set of nonlinear plant model equations.

The hybrid plant modelling paradigm employed herein describes streams by mass component flows and bulk material properties (e.g., unit enthalpy, density, heat capacity, etc.). Since process plants operate in relatively narrow regions around their normal operating conditions (NOC), each stream property π is modeled by a local approximation around determined by the corresponding temperature and pressure (T⁰, P⁰), as shown by Eq. 23:

$${π}_{i , k} = {π}_{i , k}^{0} + ( \frac{δ {π}_{i , k}}{δ {T}_{k}} ) ( {T}_{k} - {T}_{k}^{0} ) + ( \frac{δ {π}_{i , k}}{δ {P}_{k}} ) ( {P}_{k} - {P}_{k}^{0} ) \qquad ( 23 )$$

where k=stream and i=property (e.g., unit enthalpy, density, etc.). For instance, unit enthalpy is updated by Eq. 24:

$$H = {H}^{0} + Cp ( T - {T}^{0} ) \qquad ( 24 )$$

The plant model is defined by a network that connects different node models described by Eqs. 25 to 31.

A Node Mass Balance is given by:

$${\sum }_{in = 1}^{NFin} {F}_{in} - {\sum }_{out = 1}^{NFout} {F}_{out} = 0 \qquad ( 25 )$$

$${\sum }_{k = 1}^{Nk} {F}_{k} {,}_{c} - {F}_{k} = 0 , Nk ∈ ( NFin , NFout ) \qquad ( 26 )$$

Node internal equations that map input components to output components, which can be linear (Eq. 27)

$${∝}_{i , j , c} {F}_{i} {,}_{c} - {F}_{j} {,}_{c} = 0 \qquad ( 27 )$$

or in general (Eq. 28):

$$NM ( {F}_{in} , {F}_{out} , {Q}_{in} , {Q}_{out} , {F}_{k} {,}_{c} , {X}_{NM} ) = 0 \qquad ( 28 )$$

where there NM(Fᵢₙ, Fₒᵤₜ, Qᵢₙ, Qₒᵤₜ, F_{k,c}, X_{NM}) is either a linear or nonlinear hybrid model that employs component mass flows, and Qᵢₙ and Qₒᵤₜ are energy supplied or removed from the node, respectively.

A Node Energy Balance is given by:

$${\sum }_{in = 1}^{NFin} {Q}_{{F}_{in}} + {\sum }_{inq = 1}^{NQin} {Q}_{in} - {\sum }_{out = 1}^{NFout} {Q}_{{F}_{out}} - {\sum }_{outq = 1}^{NQout} {Q}_{out} = 0 \qquad ( 29 )$$

where QFⱼ is the enthalpy of stream j given by Eq. 30 and Eq. 31:

$${Q}_{{F}_{j}} = {F}_{j} {H}_{j} \qquad ( 30 )$$

$${H}_{j} = {H}_{j}^{0} + {Cp}_{j} ( {T}_{j} - {T}_{j}^{0} ) \qquad ( 31 )$$

$${H}_{j}^{0}$$

is the unit enthalpy [energy/mass] of stream j at MORs.

The plant model described by Eqs. 25 to 31 eliminates nonlinearities associated with stream fractions and with rigorous calculation of thermophysical properties. Accuracy of its local approximation of thermophysical properties, expressed in [property/mass] units, is much higher than the accuracy of such approximation based on mole flows. If heat capacities and enthalpies of vaporization are expressed in [energy/mass], they are very often close in value to other compounds that are encountered in the same process stream. Therefore, when the stream composition changes, the bulk stream properties vary much less than they would if expressed in [energy/mole]. Even though the model eliminates numerous nonlinearities associated with model fractions, it still contains F*H bilinear term for each process stream. For a 50-period model of a plant with 150 streams, that would mean solving a set of equations with at least 7,500 bilinear terms. If such models are used for discrete time scheduling (which will add binary variables) or for optimization under uncertainty, that computational task is intractable for practical use.

An aspect of this disclosure is to optimize plant operation (operating conditions, production plans or schedules) based on a linear model to ease the computational burden while achieving accuracy on par with rigorous models. Instead of selecting a specific set of equations that corresponds to a targeted process plant model accuracy, all equations that constitute a rigorous plant model are considered and the equations are ordered from less detailed to more detailed representation of specific plant attributes. Material or energy balances expressed in terms of (material or energy) stream flows plus material or energy generation (or consumption) in the nodes represent the highest level of abstraction. The node models are assumed to be linear and that the coefficients in the node models can be calculated from more detailed (rigorous or data-driven) models. After the first solution of the linear plant model, the coefficients in the node models are updated to correspond to the computed flows. The linear plant model is then resolved, and if desired, the coefficients are updated and the model is resolved again, and so on, until convergence. This approach can be generalized by defining levels of plant model abstractions of the entire set of equations corresponding to a detailed plant model and solve them by using the iteration method outlined above.

Instead of solving this model directly, the model will be replaced by the following abstractions:

Abstraction Level 1 [MF] or [Q]: Material Flows or Energy Flows only. The simplest abstraction of a plant model is comprised of material balance equations (Eqs. 25, 26, 27 or 28, with Qᵢ omitted) for process plants, or energy-flow balance equations (Eq. 29) for energy systems.

Material balance abstraction is often used in planning and scheduling models since their linear structure makes it possible to solve multi-period models efficiently. These models assume that the plant operates at a specific set of operating conditions (mode of operation), which are represented by linear node models. The disadvantage of material-balance-only models is their inability to compute energy demands and to accommodate deviations from the encoded modes of operation.

Energy-flows-only models are frequently used to study design and optimization of distributed energy systems. Since they do not include stream temperatures and flows, such models may lead to designs that are thermodynamically infeasible.

Abstraction Level 2 [MF, H⁰]: Material flows with stream unit enthalpy at standard operating conditions. Instead of defining the next, more detailed plant abstraction as containing bilinear terms, like the one presented in Eq. 26 to Eq. 31, the notion of standard operating conditions is exploited to define a model abstraction described by Eq. 25 to Eq. 29 and energy flows at fixed unit enthalpy (the unit enthalpy at normal operating conditions) of streams:

$${Q}_{{F}_{j}}^{0} = {F}_{j} {H}_{j}^{0} \qquad ( 32 )$$

Eq. 32 calculates correctly the total enthalpy of a stream at any value of flow F as long as the stream conditions (NOC as determined by temperature, pressure and composition) correspond to the normal operating conditions. This abstraction level has not been previously used in plant modeling, even though it ensures high accuracy from simple models. [MF, H⁰] abstraction can be used as a significantly more accurate incarnation of the planning and/or scheduling models, while still retaining model linearity.

To examine implications of Eq. 32, consider the Taylor series expansion of the FH term as shown in Eq. 33:

$$FH = {F}^{0} {H}^{0} + {H}^{0} dF + {F}^{0} dH = {FH}^{0} + {F}^{0} dH \qquad ( 33 )$$

If a stream is not at NOC, Eq. 32 approximates the term FH by assuming that dH=0, i.e. changes in stream flows have significantly larger impact on energy content of the streams than the changes in unit enthalpy (stream temperature). For instance, in the case of a countercurrent heat exchanger, the deviations from MORs are caused by changes in the stream flow through an exchanger, which causes changes in the outlet temperatures of the heat exchanger.

Heat exchanger duty corresponds to Eq. 34. given below:

$$Q = F ( {H}_{in} - {H}_{out} ) = F [ ( {H}_{in}^{0} + {Cp}_{in} ( {T}_{in} - {T}_{in}^{0} ) ) - ( {H}_{out}^{0} + {Cp}_{out} ( {T}_{out} - {T}_{out}^{0} ) ) ] \qquad ( 34 )$$

If Cpᵢₙ≈Cpₒᵤₜ, then Eq. 34 becomes Eq. 35 as shown below:

$$Q = F ( {H}_{in}^{0} - {H}_{out}^{0} ) + F * Cp [ ( {T}_{in} - {T}_{in}^{0} ) - ( {T}_{out} - {T}_{out}^{0} ) ] \qquad ( 35 )$$

Therefore, the assumption that deviation of the stream unit enthalpy dH=0 means that the change from NOCin the inlet temperature of a stream is equal to the change from NOCin the outlet temperature of the stream. As shown by the computational results below, this approximation does not cause large deviation from the true solution even for large deviations (25%) from the flows at which NOCproperties of the streams have been recorded.

It is assumed that the node models can be represented by linear sets of equations and that the parameters in these equations are updated at each iteration of the algorithm. For instance, compressor efficiency may be set to an average efficiency over the expected range of flows. Once the solution is obtained, the efficiency is updated to the value corresponding to the calculated flow through the compressor. Similarly, distillation tower models can be recast in terms of component flows. Reactor models can be cast in terms of mass component yield of key products, and flows of the remaining components can be computed from stoichiometry-based material balance. An alternative is to create a neural network model of a node and then convert it to an LP or MILP model.

This plant model abstraction yields results that compute flows and energy balances very close to the solution of Eqs. 25 to 31. If the plant model includes the process side and the utility side of the plant, then Eqs. 25 to 29 and 32 are a linear model of the plant that yield a solution that is very close to the exact solution of Eqs. 25 to 31.

Abstraction Level 3 [MF⁰, H]: Material flows are given; compute accurate energy balances. The solution of [MF, H⁰] abstraction models are flows and approximate energy balances, including a utility system's flows and energy usage. If the flows are different from the flows at which the unit enthalpies at normal operating conditions are computed, the unit enthalpy of the streams leaving each exchanger is different from H⁰ used in Eq. 32.

To optimize the operating conditions, the temperature and the unit enthalpy of each stream are accurately computed, which is accomplished by solving the plant energy balance equations. For heat exchangers without partial condensation (evaporation), since the flows through the plant are known (they are computed by the Level 2 model), the energy balance for each stream ‘s’ through an exchanger is a linear equation where Tₒᵤₜ is unknown (Eq. 36), because Tᵢₙ is either the temperature of an outlet stream from another exchanger or a stream leaving a process unit.

$${Q}_{s} = {F}_{s} [ ( {H}_{in}^{0} + {{Cp}_{in} ( {T}_{in} - {T}_{in}^{0} )}_{s} ) - {( {H}_{out}^{0} + {Cp}_{out} ( {T}_{out} - {T}_{out}^{0} ) )}_{s} ] \qquad ( 36 )$$

Heat transferred in a countercurrent heat exchanger is described by LMTD equation, which is highly nonlinear. LMTD equation is reformulated to calculate heat exchanger duty Qₕₓ as a function of a duty Q_{base} of an exchanger at known conditions (flows, temperature, heat exchange area, and heat transfer coefficient) as follows (Eq. 37):

$${Q}_{hx} = {Q}_{base} Φ ( flows ) ( {T}_{hot , in} - {T}_{cold , in} ) \qquad ( 37 )$$

where Φ(flows) is a parameter that depends on the ratios of the current flows to the base flows and the ratio of the current heat transfer coefficient to the one in the base case.

It is assumed that each node model, for given flows to and from the node, calculates its outlet temperature. Energy balance node models, together with Eqs. 34 and 37 for heat exchangers, comprise an accurate, linear energy balance model of the plant. Its solution provides correct temperatures for each stream in the plant, when the flows are equal to the values computed from [MF, H⁰] abstraction.

Abstraction Level 4 [MF, H]: Material flows and enthalpies computed simultaneously. This abstraction is defined by Eqs. 25 to 31 above. Further abstraction levels can be defined by including additional equations.

Abstraction Level 5 [MF, H, rigorous properties]: This corresponds to a rigorous plant model similar to the models built by using Aspen Plus or gPROMS or IDAES.

To achieve consistency of solutions for different business purposes, the present inventors propose an algorithm that progressively moves from simpler to more detailed models by solving subsets of equations, based on a fixed-point block iteration method.

Let F(x)=0 be the set of all equations in this example, and the equations are reformulated into a fixed-point form x=G(x). The vector x can be partitioned into blocks, e.g., x=[x₁,x₂, . . . ,xₘ]^{T}, where one block of variables corresponds to the stream flows, while the other block of variables corresponds to the coefficients in the node models. Solving the linear plant model to compute the flows and then solving each node model equations to compute the coefficients in the node model is a sequential update of the blocks of variables, where most recently computed values from other blocks are used within the current iteration, i.e., at each iteration:

For each block i, where i=1,2, . . . ,m

$${x}_{i}^{k + 1} = {G}_{i} ( {x}_{1}^{k + 1} , … , {x}_{i - 1}^{k + 1} , {x}_{i}^{k} , {x}_{i + 1}^{k} , … , {x}_{m}^{k} ) \qquad ( 38 )$$

Since iterations represented by Eq. 38 may not converge, the step size can be reduced as shown in Eq. 39:

$${x}_{i}^{k + 1} = {x}_{i}^{k} + α [ {G}_{i} ( {x}_{1}^{k + 1} , … , {x}_{i - 1}^{k + 1} , {x}_{i}^{k} , {x}_{i + 1}^{k} , … , {x}_{m}^{k} ) - {x}_{i}^{k} ] ; α \leq 1 \qquad ( 39 )$$

If the number of iterations is more than a handful, one can apply acceleration techniques. This algorithm is a basis for sequential modular calculation of flowsheets with recycles but has not been used until now for the equation-oriented approach of flowsheet simulation and optimization.

To solve (or optimize) the Level 4 [MF, H] model, the composite algorithm solves (optimizes) in Phase I the Level 2 [MF, H⁰] model, followed by solving in Phase II the Level 3 [MF⁰, H] of Iterations between Phase I and Phase II are repeated until convergence on the stream temperatures or enthalpies is achieved.

The term “composite algorithm” is used due to the algorithm using “external” calculations to update the parameters. A high-level framework for the composite algorithm may be provided as follows:

### Initialization:

Determine stream attributes [property/mass] for all streams in the plant. For hydrogen plant, these are stream unit enthalpies at specified temperatures and pressures; also determine the stream heat capacity, which will be used to update the enthalpy at new temperature.
(Either by measuring stream temperatures, pressures, and composition and then using rigorous property calculation package or by simulating the plant via rigorous models)

Phase I: Solve Abstraction [MF, H⁰] model.
The solution provides stream flows, component flows, and energy balances (the latter corresponds to normal operating conditions).

Post-Phase I: (i) Update parameters dependent on the flows by using values computed in Phase I. The update may be, e.g., efficiencies of compressors, or heat transfer coefficients for heat exchangers, or component yield in reactors, etc. corresponding to the flows as calculated in Phase I. (ii) Improve the node model prediction by an additive or multiplicative correction term that guarantees the desired level of accuracy in the current operating region.

Phase II: Solve Abstraction [MF⁰, H] model, energy balances and heat transfer models.
This step improves the accuracy of the energy balances computed in Phase I. Calculate stream unit enthalpy via eq. 29, where T is temperature computed in Phase II. Update other bulk stream properties (e.g., density, viscosity, etc., if they are included in the model) to correspond to the new value of T.

Post-Phase II: If the updated stream temperatures impact the accuracy of node models used in Phase 1, update the corresponding parameters of such node models.

Converged? If the stream properties have converged, proceed. Otherwise, go to Phase 1.

Is the solution in a region where it is desired to update local property models?
If local property models are to be updated via rigorous methods (for a specific stream), update them from rigorous property models and go to Phase 1. Otherwise proceed.

End Solution achieved.

Note: at each update step, use a relaxation factor (Eq. 39) less than 1.0 if necessary to prevent divergence.

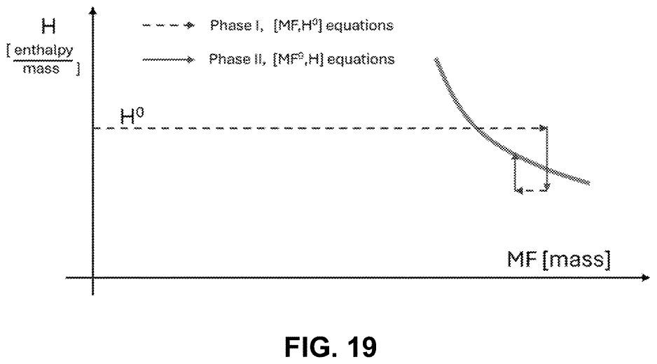

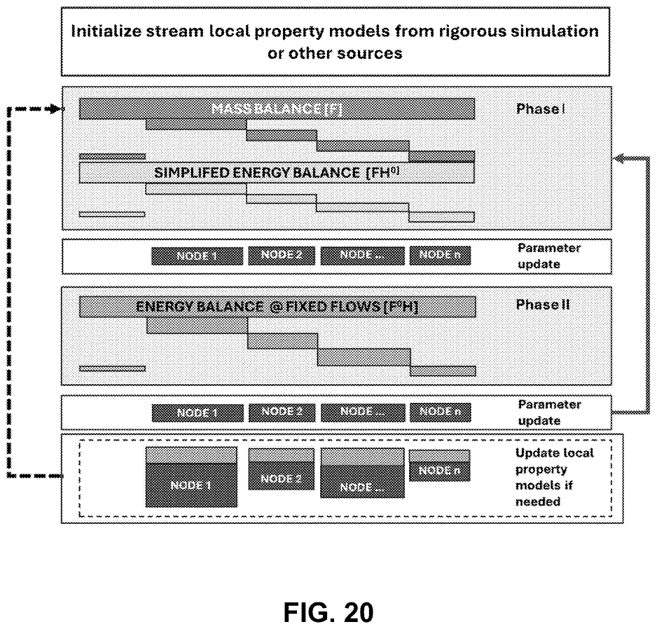

Phase I computes an approximate optimum solution by varying the flows, while Phase II restores feasibility if the parameters used in Phase I are not sufficiently accurate, as illustrated in FIG. 19. A schematic of the algorithm is presented in FIG. 20.

In production planning models, process units often operate in different modes, each of them having a different set of operating conditions. Similarly to the practice in LP models for e.g., refinery planning, in the novel paradigm each unit that operates in several modes would be represented by the same number of node models, where each node model would be instantiated via a model version corresponding to that mode or operation. Local property models can be updated from the physical properties package as desired.

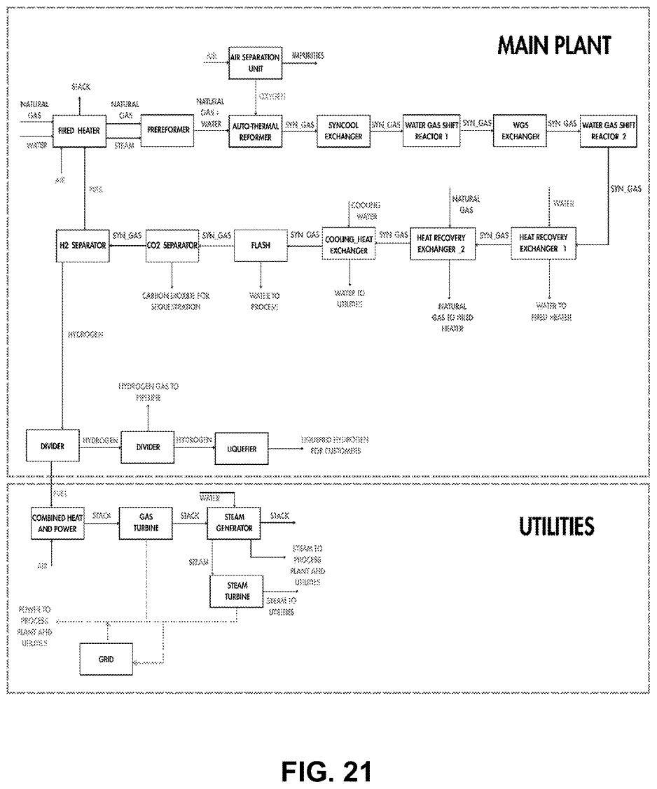

In an example application of the composite algorithm disclosed herein, a blue hydrogen plant produces hydrogen via the autothermal reformation of methane in an autothermal reactor (ATR). The feed to the plant is natural gas, which is mostly methane. Most of the carbon dioxide (CO₂) produced by the plant is captured and sent to sequestration in underground storage. Hydrogen produced by the plant is predominantly shipped via pipeline, while about 5% of the production is delivered locally as liquid hydrogen. The plant also has an air separation unit that produces oxygen for autothermal reforming and a CHP, which produces electricity and heat. This heat is used in the heat recovery steam generators, where steam is produced for various process and utility operations. Electricity to the plant is supplied either by the CHP or by the electrical grid. If grid electricity is very expensive, the plant can improve its profitability by exporting the surplus electricity produced by CHP to the grid. A simplified flow diagram of the plant is shown in FIG. 21 below.

In the plant model, based on the paradigm described herein, each stream is described by its bulk properties (unit enthalpy, heat capacity, density, etc.) at normal operating conditions. In addition, parameters for the local property approximation are in the neighborhood of the NOCs. These values are obtained by creating a rigorous plant model in, e.g., Aspen Plus or PRO/II and then exporting the relevant stream properties. Since stream physical properties are updated to the actual conditions via local models, the model created during plant design can be used for this purpose. Alternatively, one can use the physical properties package by providing stream temperature, pressure and composition.

The present inventors propose that a hybrid model can have an accurate model (within 1% error relative to the rigorous model) and can be solved very efficiently for multiperiod planning or discrete time multi-period scheduling or for real-time optimization. As such, much more accurate planning and/or scheduling models can be solved via the composite algorithm presented above, thereby eliminating model inaccuracies in such applications.

The hybrid plant model of the blue hydrogen plant, including utilities, CHP, air separation unit, and the process units, is comprised of 107 nodes connected by 141 streams. It is based on the blue hydrogen plant described in the NETL report. Model accuracy has been verified at feed rates between 80% and 125% of the base case feed rate by comparing the values from the hybrid model to the Aspen Plus model, as shown in Table 2 for the key flows in the plant.

The autothermal reforming (ATR) reactor and water-gas shift (WGS) reactor are modelled well by a highly nonlinear mole-fraction based RGibbs reactor in Aspen Plus.

Production of hydrogen in ATR is represented accurately by Eq. 40, where x are mass fractions of components in the reactor feed and y_{H} is mass fraction of hydrogen at the exit, while T[K] is the reactor temperature.

$${\sum }_{j = 1}^{NC} {a}_{j} {x}_{j} + {a}_{y} {y}_{H} + {a}_{T} T = 0 \qquad ( 40 )$$

Since the mass flow of the feed F_{feed} to the reactor is equal to the mass flow of products leaving the reactor (which is not the case if amounts are expressed in moles), one can multiply Eq. 40 by feed mass flow to obtain:

$${\sum }_{j = 1}^{NC} {a}_{j} {F}_{j} + {a}_{y} {F}_{{H}_{lin}} + {a}_{T} {F}_{feed} T = 0 \qquad ( 41 )$$

Since the ATR reactor operates at a fixed (as high as possible, subject to the thermal properties of the construction materials) temperature, Eq. 41 is used in Phase I. Models analogous to Eq. 41 are used to model the flow of CO and CH₄ at the outlet from ATR. The remining components are computed from the stoichiometry of the reactions in ATR. For a given ATR temperature, the oxygen flow is computed from Eq. 42.

$$a * {F}_{in , CH 4} + b * {F}_{in , H 2 O} + c * {T}_{{F}_{in}} + d * {T}_{{F}_{out}} + e * {F}_{feed} = {F}_{in , O 2} \qquad ( 42 )$$

The relative error of the hydrogen product stream is 1.2%, while the remaining streams have less than 0.5% error.

Examples of ATR and WGS reactors show that at least for some reaction mechanisms (RGibbs) the change from mole to mass fractions (mass components) leads to models that can be partitioned into a linear part (Eqs. 41 and 42) that is used in Phase I, and parameter update post-Phase I enables inclusion of model nonlinearities (either from empirical models or from a rigorous reactor model that can be invoked in post-Phase I).

Separation of multicomponent mixtures is represented in the model via the component split fraction model described by Eq. 28. If a more accurate representation is desired, then post-Phase 1, one can update the split fractions and unit enthalpy of outlet streams using a more accurate model, e.g., a hybrid model (preferred, due to rapid calculation) or a rigorous model.

In Phase 1, compressor efficiency is a parameter. Post Phase 1, compressor efficiency can be updated from a nonlinear model, e.g., Eq. 43:

$$η = α * θ + β * {θ}^{3} + γ \qquad ( 43 )$$

where, η is the efficiency of the compressor, α, β and γ are the coefficients of normalized flow rate denoted by θ. Updating efficiencies for three compressors post-Phase I has not increased the computation times when compared to a model with efficiencies being kept constant.

Data used in the optimization examples emulate real-world variations in electricity prices, hydrogen demand, and carbon intensity index constraints. Prices of natural gas, cooling water, and process water are assumed to be constant.

The Objective is to maximize the profit over T time periods, Eq. 44.

$${Max}_{1 < i < n} {\sum }_{i ∈ 𝒥} [ {Price}_{H 2 , liq} \cdot H {2}_{{liq}_{i}} + {Price}_{H 2 , gas} \cdot H {2}_{{gas}_{i}} + {Price}_{electricity , export} \cdot {Electricity}_{{export}_{i}} ] - {\sum }_{i ∈ 𝒥} [ {Price}_{NG} \cdot ( {NG}_{{process}_{i}} + {NG}_{{Fuel}_{i}} + {NG}_{{UNG}_{i}} + {NG}_{{AFTB}_{i}} ) + {Price}_{H 2 O , process} \cdot H 2 {O}_{{process}_{i}} + {Price}_{H 2 O , cooling} \cdot H 2 {O}_{{cooling}_{i}} + {Price}_{electricity , import} \cdot {Electricity}_{import , i} ] \qquad ( 44 )$$

Where H2_{liq} and H2_{gas} are flows of liquefied and gaseous hydrogen product, NG represents the flow of natural gas, H2O represents the flows of water. Subscript process represents the process side of the plant, Fuel represents the fuel to the fired heater, UNG is the fuel to the CHP unit, AFTB is the afterburner positioned downstream of the CHP unit, cooling stand for the cooling side.

In addition to constraints representing the plant operation, the multi-period optimization model includes Carbon Intensity (CI) constraint. Cl limits the amount of CO2-equivalent emissions per unit of energy content of the hydrogen produced in a given time period. It is imposed by the customer demands to have limited CO2 emissions associated with the hydrogen they use due to lifecycle assessment (LCA) standards such as those set by Canada's Clean Fuel Regulations (CFR) 34. In the model, Cl is defined in Eq. 45:

$${CI}_{t} = \frac{{Emissions}_{t}}{{Energy}_{H 2 , t}} ∀ t ∈ 𝒯 \qquad ( 45 )$$

where:
Emissionsₜ: total CO₂-equivalent emissions in period t (g CO²ₑ),
Energy_{H2,t}: higher heating value (HHV) energy content of liquid and gas hydrogen produced in period t (MJ),
Clₜ: resulting carbon intensity (g CO²ₑ/MJ).
[symbol] T is the set of time periods.

The amount of emissions in period t is calculated by Eq. 46:

$${Emissions}_{t} = CO {2}_{on - site , t} + {NG}_{t} \cdot {HHV}_{NG} \cdot {EF}_{NG} + {Power}_{import , t} \cdot {EF}_{grid , import} - {Power}_{export , t} \cdot {EF}_{grid , export} \qquad ( 46 )$$

where emissions are calculated as the sum of:
CO2_{on-site,t}: On-site CO₂ emissions in period t (g CO²ₑ),
Upstream emissions associated with the natural gas feedstock, based on a defined emission factor EF_{NG}, higher heating value (HHV) of natural gas and the used amount,
Grid electricity import emissions, weighted by an import emission factor EF_{grid,import}
Minus a credit for grid electricity exported, calculated using an export emission factor EF_{grid,export}.

All terms in Eq. 46 are tracked and constrained over the time horizon T.

A time-dependent upper limit on Cl (Eq. 47) is enforced as:

$${CI}_{t} \leq {CI}_{max , t} , ∀ t ∈ 𝒯 \qquad ( 47 )$$

Since different customers impose different Cl limits, the length of the time periods can be adjusted so that each time period corresponds to production for a customer with different Cl bound. This involves efficient solution of models with a fairly large number of time periods, e.g., or 40 time periods.

The multi-period model of annual production does not include any inventories. Each period is represented by the same set of equations. Even though the model does not contain inventory tanks that would connect between the periods, the model size illustrates that the algorithm scales well with the increase in the model size.

Presented in Table 2 are also the stream flows computed at the first iteration and at the last iteration of the composite algorithm. If the tolerance on converging the stream temperatures is ε=1.0 K, the model converges in 4 iterations. If the tolerance is ε=0.1 K, then 7 iterations are used for the model to converge. As shown in Table 2, there is a negligible difference in computed flows with these two tolerances. Therefore, it is sufficient to use 1.0 K tolerance as the criteria for convergence on stream temperatures.

TABLE 2
Flowrates [kg/hr.] at different feed rates (100% = 96,930 kg/hr.)

| | Feed rate as % | | | | | | | |
|---|---|---|---|---|---|---|---|---|
| | Natural | | | H₂ | H₂ | | CO₂ | |
| | Gas | H₂O | O₂ | from | from | H₂ | from | CO₂ |
| | feed | feed | feed | ATR | WGS-2 | Produced | WGS-2 | Produced |
| Aspen Plus: | 77,544 | 131,875 | 102,280 | 17,850 | 24,224 | 20,680 | 200,251 | 190,496 |
| Feed = 80% | | | | | | | | |
| Iteration 1 | 77,544 | 131,874 | 101,686 | 17,908 | 24,206 | 20,664 | 200,081 | 190,335 |
| Iteration 4 (ε(T) ≤ 1) | 77,544 | 131,874 | 101,885 | 17,894 | 24,195 | 20,655 | 200,200 | 190,448 |
| Iteration 7 (ε(T) ≤ 0.1) | 77,544 | 131,874 | 101,867 | 17,895 | 24,196 | 20,656 | 200,198 | 190,446 |
| Aspen Plus | 96,930 | 164,844 | 127,850 | 22,313 | 30,280 | 25,855 | 250,315 | 238,136 |
| Feed = 100% | | | | | | | | |
| Iteration 1 | 96,930 | 164,843 | 127,107 | 22,385 | 30,257 | 25,831 | 250,101 | 237,918 |
| Iteration 4 (ε(T) ≤ 1) | 96,930 | 164,843 | 127,357 | 22,367 | 30,243 | 25,819 | 250,251 | 238,061 |
| Iteration 7 (ε(T) ≤ 0.1) | 96,930 | 164,843 | 127,334 | 22,369 | 30,245 | 25,821 | 250,248 | 238,058 |
| Aspen Plus: | 106,623 | 181,328 | 140,635 | 24,545 | 33,308 | 28,438 | 275,346 | 261,942 |
| Feed = 110% | | | | | | | | |
| Iteration 1 | 106,623 | 181,327 | 139,818 | 24,624 | 33,283 | 28,414 | 275,111 | 261,710 |
| Iteration 4 (ε(T) ≤ 1) | 106,623 | 181,327 | 140,093 | 24,604 | 33,268 | 28,401 | 275,280 | 261,871 |
| Iteration 7 (ε(T) ≤ 0.1) | 106,623 | 181,327 | 140,068 | 24,606 | 33,270 | 28,403 | 275,277 | 261,868 |
| Aspen Plus: | 121,162 | 206,054 | 159,813 | 27,891 | 37,850 | 32,312 | 312,893 | 297,649 |
| Feed = 125% | | | | | | | | |
| Iteration 1 | 121,162 | 206,054 | 158,884 | 27,982 | 37,821 | 32,289 | 312,626 | 297,398 |
| Iteration 4 (ε(T) ≤ 1) | 121,162 | 206,054 | 159,196 | 27,959 | 37,804 | 32,274 | 312,818 | 297,581 |
| Iteration 7 (ε(T) ≤ 0.1) | 121,162 | 206,054 | 159,168 | 27,961 | 37,807 | 32,276 | 312,815 | 297,577 |

Table 3 shows temperatures of the streams (at 125% feed rate) that have either partial condensation or phase change of the material. Even though these temperatures have been computed by using local approximations of physical properties and approximate two-phase heat exchanger models, the maximum temperature difference is 3 K.

TABLE 3
Comparison of stream temperatures: Aspen Plus vs. hybrid model.

| | Syngas | | | | LTHR-1 | LTHR-1 | LTHR-1 | LTHR-2 | LTHR-2 | LTHR-2 | LTHR-2 |
|---|---|---|---|---|---|---|---|---|---|---|---|
| | Cooler | WGS-1 | WGSHX | WGS-2 | Hot | Cold | Cold | Hot | Hot | Cold | Cold |
| Model | Out | Out | Out | Out | Out | In | Out | In | Out | In | Out |
| Aspen | 477.6 | 625.2 | 477.6 | 499.6 | 419.5 | 316.3 | 449.8 | 419.5 | 414.3 | 288.2 | 411.7 |
| Hybrid | 477.3 | 622.4 | 476.1 | 498.5 | 422.3 | 317.2 | 446.8 | 422.3 | 416.6 | 288.2 | 410.5 |
| Error (%) | 0.07 | 0.45 | 0.31 | 0.22 | 0.67 | 0.29 | 0.67 | 0.67 | 0.56 | 0.00 | 0.29 |

Abbreviations in Table 2 and Table 3 represent: ATR=autothermal reforming reactor, WGS=water gas shift reactor, LTHR=low temperature heat recovery heat exchanger, WGSHX=heat exchanger between WGS-1 and WGS-2 reactors.

Since the model has accuracy on par with Aspen Plus, and it includes the main degrees of freedom (feed rate, ATR reactor temperature, recycling impure hydrogen to the CHP unit to keep Cl under its maximum constraint, exporting or importing electricity to/from the grid, etc.), it can be used for real-time optimization of the plant operation. It can also be used for multi-period production planning while keeping the accuracy on par with Aspen Plus.

The model has been implemented in PYOMO. Switching from one set of equations in Phase I to another set of equations in Phase II is accomplished by using PYOMO capability to activate or to deactivate equations. The number of variables and constraints in Phase I and in Phase II for different time periods is shown in Table 4.

TABLE 4
Model size vs. number of time periods.

| Time | | Phase I | Phase II |
|---|---|---|---|
| Horizon | Number of | Number of | Number of |
| (Periods) | Variables | Constraints | Constraints |
| 1 | 10,022 | 8,454 | 7,199 |
| 6 | 60,132 | 50,724 | 43,194 |
| 12 | 120,264 | 101,448 | 86,388 |
| 24 | 240,528 | 202,896 | 172,776 |
| 36 | 360,792 | 304,344 | 259,164 |
| 48 | 481,056 | 405,792 | 345,552 |

The size of the model grows linearly with the number of time periods. Please note that this does not include equations that are used after Phase I or after Phase I to update the model parameters.

Since the model has 141 streams, the model would have at least 141 bilinear terms per one time period with the [MF, H] paradigm. A 48 time periods model would have at least 6,768 bilinear constraints.

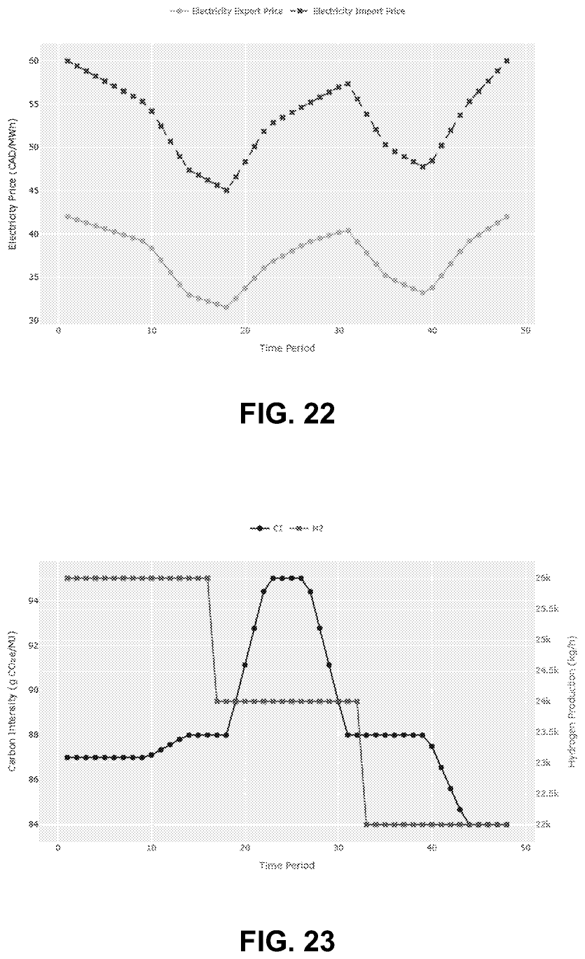

Optimal operation over an extended time horizon depends on the time-dependent cost, product demand, and constraints on Cl. Data was generated to resemble real-world situations; no proprietary data have been used in an example of 48 period optimization. Electricity import and export prices from/to the grid are shown in FIG. 22. They both follow the same pattern, but the price of exports to the grid is always lower than the cost of purchasing electricity from the grid. The upper bound on Cl and hydrogen demand data are shown in FIG. 23. In periods 23 to 26, the Cl maximum allowed value of Cl is quite high, while in periods 44 to 48 it is the lowest.

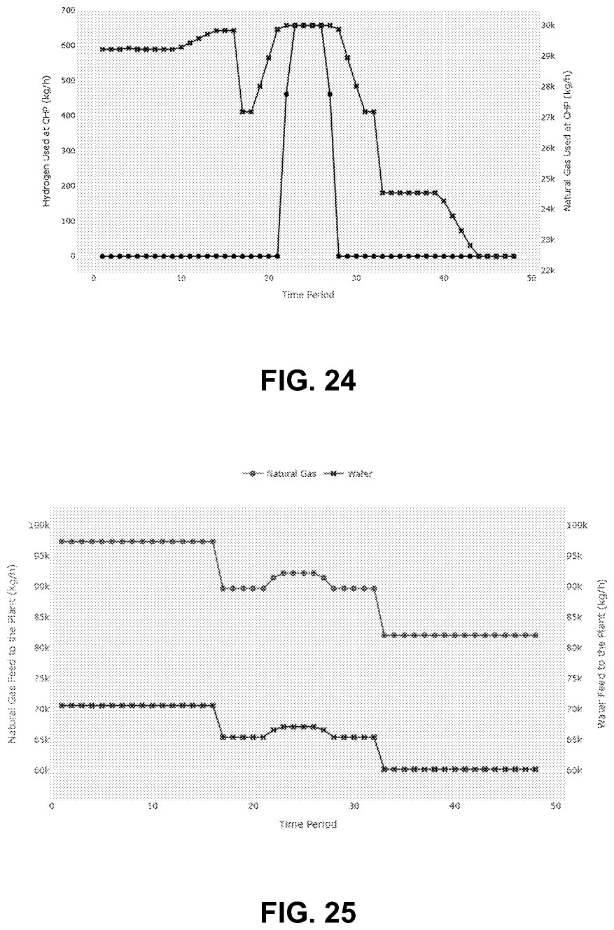

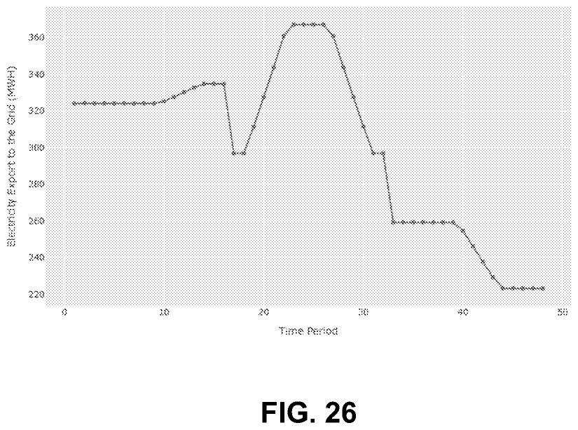

Demand, maximum Cl constraint, and the price of electricity from the grid govern the plant operation. FIG. 24 depicts hydrogen and natural gas used in CHP. When the Cl limit is very high, the plant burns more natural gas to produce more electricity in order to export more electricity to the grid, since the CHP unit has sufficient capacity to always meet the demands of the plant, as shown in FIG. 26.

If electricity exported to the grid is generated by burning only natural gas, the plant Cl increases. If the increased Cl would be higher than the upper limit, the plant uses impure hydrogen, mixed with natural gas, as fuel in CHP, to stay below the maximum Cl constraint, as shown in FIG. 24, periods 23 to 26. On the other hand, if max. Cl constraint is low, as shown in FIG. 24, periods 44 to 48, electricity export to the grid is at its minimum as shown in FIG. 26, even though the electricity export prices are high (FIG. 22).

Natural gas feed and water feed to the plant are shown in FIG. 25. They are proportional to each other, which is governed by the steam consumption in the pre-reformer and the steam usage as process steam (in turbines or in heat exchangers).

PYOMO enables object-oriented implementation of nodes, ports, and streams. It also has convenient ways of turning on and off sets of equations. In order to solve one set of equations in Phase 1, and then solve a different set of equations in Phase II, at each iteration of the Composite Algorithm and in each Phase, the code performs the following:
i. Generate equations
ii. Write Gurobi input file (“Write File”).
iii. Gurobi presolves the set of equations (“Presolve”)
iv. Gurobi solves the model equations (“Solve”)
v. Read Gurobi solution file into PYOMO (“Read file”)
vi. PYOMO executes post-solve mapping into original variables (“Post Solve”)

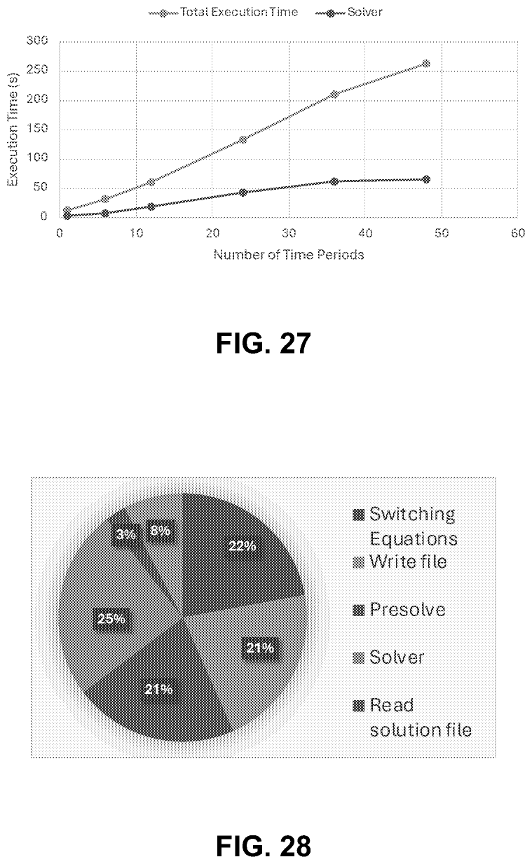

Table 5 summarizes the time for each of these steps in Phase I and Phase II. FIG. 27 shows that the Total Time and the Solve time increase almost linearly with the number of time periods. The computations were carried out on a desktop PC with an Intel Core i7-9700 CPU (3.00 GHz) and 16 GB of memory. Table 5: Breakdown of the execution times of the Composite Algorithm steps.

TABLE 5
Breakdown of the execution times
of the Composite Algorithm steps.

| Time | Total | Switching | Write | | | Read | Post |
|---|---|---|---|---|---|---|---|
| Horizon | Time | Equations | File | Presolve | Solve | File | Solve |
| (Periods) | [s] | [s] | [s] | [s] | [s] | [s] | [s] |
| 1 | 12.28 | 3.53 | 2.33 | 2.4 | 3.06 | 0.85 | 0.11 |
| 6 | 31.37 | 3.17 | 8.48 | 8.58 | 7.36 | 3.02 | 0.76 |
| 12 | 60.33 | 3.09 | 15.97 | 16.03 | 18.72 | 5.07 | 1.45 |
| 24 | 132.85 | 10.75 | 31.1 | 32.11 | 42.59 | 11.88 | 4.42 |
| 36 | 210.23 | 22.78 | 49.92 | 50.57 | 61.77 | 19.75 | 5.44 |
| 48 | 262.6 | 58.02 | 55.86 | 56.2 | 65.06 | 20.32 | 7.14 |

Clearly, there is a significant overhead incurred due to repeated writing of Gurobi input file, switching equations, and presolving, as shown in FIG. 28.

Since the same [MF, H⁰] model is solved at all iterations of Phase I and the same [MF⁰, H] is solved at all iterations of Phase II, a more efficient implementation would shorten significantly all of these steps and lead to much shorter execution times.

To verify solution accuracy, the solution of the smaller, single period, nonlinear plant model (66 nodes and 67 streams, 3,970 variables, 2,960 constraints, 568 nonlinear terms) via CONOPT (2.7 seconds solver time on NEOS server) was found to be the same as the solution of Phase I/Phase II model (3,970 variables, 3009 constraints) via composite algorithm (0.7 seconds solver time on i7-9700 3.00 GHz, 16 GB memory desktop).

Since the blue hydrogen plant model does not have linking between time periods, an example of solving a multi-period model with linkage via storage is provided. In an unrelated example, operation of borehole thermal storage has been optimized by the fixed-point block iteration method. The model has 84 periods; the couplings between the periods are the energy content and the temperature of different model cells. The model has 464,434 variables and 464,098 constraints. Starting from the same initialization point, the block iteration method took 983 seconds while IPOPT took 10,462 seconds to reach the optimum. Since the sparsity pattern in the plant model is different from the sparsity pattern of the borehole thermal energy storage, this example illustrates that for strongly coupled multi-time period models the proposed method is competitive with direct methods.

The present inventors propose an approach to solving plant models in a manner that leads to consistent solutions from one level of abstraction to another. Instead of solving the entire set of the plant model equations, specific desired level of accuracy can be achieved by iteratively solving additional subsets of the plant model. Such approach is made possible by iterative fixed-point block iteration method. Changing stream attributes from total molar flow and mole fractions to component mass flows and adopting local thermophysical property models has enabled solving the model equations by iterative solutions of linear subsets of equations. In addition, describing streams in terms of mass and local property models makes this modelling paradigm more suited for data-driven and hybrid models, since plant measurements are in mass or volume flows, not in moles.

For plant models that are described by bilinear terms [MF*H], i.e., (mass flow)*(unit enthalpy), the [MF, H] set of equations is replaced by mass and energy balances at nominal stream operating conditions, [MF, H0], and another set of equations [MF0, H] where flows are fixed and the enthalpies are computed so that they correspond to the given stream flows.

The two-phase Composite Algorithm first solves the [MF, H0] equations, then updates parameters that depend on the flows, and then solves the [MF0, H] equations, including the stream unit enthalpy and the stream temperature updates based on the local thermodynamic properties.

The solution of the [MF, H0] set of equations contains both material balances and energy balances that treat unit enthalpy H0 as a parameter. Unit enthalpy update H=H(Cₚ, T, P) replaces H0 by the new value after Phase II of the current iteration. This leads to the correct value of enthalpy at the convergence, and therefore optimization of the [MF, H0] equation set leads to correct optimal plant operation.

Computational results show that execution times of the Composite Algorithm vary almost linearly with the number of time periods when optimizing a multi-period model of a blue hydrogen plant.

Since
i. The hybrid plant model based on [MF, H0] and [MF0, H] abstractions lead to very accurate solutions (within 1% of the rigorous plant model),
ii. The execution times are linear with the number of periods, and
iii. Optimization results are computed from the linear [MF, H0] model,
   It follows that the same model can be used for real-time optimization, for discrete-time multi-period scheduling, and for multi-period planning.

For large models, as the degree of rigor (i.e., number of nonlinear equations) increases, one could parallelize parameter updating by executing each rigorous model on a separate CPU. Alternatively, data-driven or hybrid models can also be used to estimate parameters in the plant-level mass and energy balance equations.

The present inventors propose a composite algorithm which introduces a different paradigm for solving plant model equations. This enables computation of consistent solutions among different levels of plant model abstractions. Iterative solutions of increasingly more detailed model equations make it possible to stop adding additional subsets of equations when the desired level of accuracy is achieved. For instance, for planning and scheduling models for which accuracy on par with rigorous models is not desired, one can iterate only on the Phase I set of equations and update only their parameters.

The present inventors propose abstraction level [MF, H0] which corresponds to a novel, previously not employed, plant description having accuracy that approximates the rigorous model, and yet it is linear.

The present inventors propose that since the plant-level optimization is based on a linear subset of model equations, high accuracy, mixed integer models for e.g., superstructure optimization or production scheduling, the solution will likely be possible faster than the corresponding MINLP models.

Achieving consistent solutions among different levels of model abstraction via successive optimization of models solved via block iteration is likely to be appropriate up to the point when the entire plant model is instantiated by a complete set of rigorous model equations (based on streams described by component flows). At that point, switching to other methods for optimizing single period model or to nested Schur decomposition for multiperiod problems is likely to converge faster.

The present inventors propose a method comprising:
instantiating a plant model from a detailed plant topology corresponding to a process flow diagram (PFD), the same topology being reused across planning, scheduling, real-time optimization (RTO), control, and other plant-model versions wherein variable identifiers for streams and nodes are identical across layers and periods such that feasibility, variable identity, and initializations are preserved without remapping; selecting, for each node in the topology, a node-model incarnation corresponding to a desired level of abstraction, wherein the node-model incarnations include at least mass-balance-only, or mass-and-energy with stream enthalpy fixed at normal operating conditions, or mass-and-energy with updated enthalpies at fixed flows, and optionally models including rigorous thermophysical properties wherein a subset of early time periods may instantiate hybrid MPC node model incarnations and a subset of later time periods shall instantiate [MF,H] node model incarnations;
representing each stream by component mass flows and bulk thermodynamic properties expressed per unit mass, such that plant-level balances include terms of the form [mass flow]×[property per unit mass];
solving the plant model using a composite algorithm that alternates between Phase I that is formulated as LP or MILP and Phase II that is formulated as LP only:
   a. Phase I, solving or optimizing a linear plant model comprising mass balances and energy balances using unit enthalpy fixed at normal operating conditions and including discrete decision variables if such variables are needed to decide on optimal plant operation; and
   b. Phase II, solving a linear energy-balance model with flows fixed from Phase I to compute updated stream temperatures and enthalpies;
updating stream properties between Phases I and II, including applying a local unit-enthalpy update, and optionally refreshing one or more stream properties from a rigorous thermophysical model when deviation from normal operating conditions exceeds a selected threshold wherein rigorous property refresh is performed only for streams in a declared critical-set when |T−T⁰|<ΔTₘₐₓ or |P−P⁰|>ΔPₘₐₓ, with at most one refresh per Phase-II iteration and with relaxation α ∈ (0,1] applied on returned properties;
iterating Phases I and II until a convergence criterion on stream temperatures and/or enthalpies is satisfied; and
applying the unified topology across multiple decision layers and/or time periods such that solutions at one abstraction level are used to initialize and maintain consistency with solutions at another abstraction level.

The present inventors propose a system for unified plant modeling and optimization comprising at least one processor and memory storing instructions that are comprised of: Topology Based Plant Model Equation factory that enforces variable across abstraction layers and periods; Node Library providing per-period node model version (abstraction level); Property Services that provide local or rigorous property updates; Solver Service that provides Composite Algorithm. When executed they cause the system to be:
i. enforcing variable identity across layer and periods: store and reuse a detailed PFD-based plant topology across decision layers.
ii. provide node-model multiple incarnations per node corresponding to different abstraction levels and enforcing per-period node-model version policy.
iii. maintain stream-property data including H⁰,Cₚ,T⁰,P⁰, apply local enthalpy updates, and optionally perform rigorous-property refreshes.
iv. construct and solve Phase I and Phase II linear models according to a composite algorithm; and
v. generate consistent multi-period or multi-layer solutions on the same topology.

The present inventors propose that the node-model incarnations comprise levels [MF], [MF, H⁰], [MF⁰, H], [MF, H], and [MF, H_{rigorous properties}]

The present inventors propose that streams are described exclusively by component mass flows without mole fractions, eliminating mole-fraction bilinearities at mixers, splitters, and separators thereby excluding models that compute or conserve mole fractions at any mixer, splitter, or separator node in the [MF], [MF,H⁰], and [MF⁰,H] incarnations. [MF], [MF,H₀], and [MF⁰,H] exclude mole fractions and flash computations.

The present inventors propose that each stream property, e. enthalpy is updated using a local relation

$${π}_{i , k} = {π}_{i , k}^{0} + ( \frac{{δπ}_{i , k}}{δ {T}_{k}} ) ( {T}_{k} - {T}_{k}^{0} ) + ( \frac{{δπ}_{i , k}}{δ {P}_{k}} ) ( {P}_{k} - {P}_{k}^{0} ) ,$$

which for unit enthalpy becomes H=H⁰+Cₚ(T−T⁰) and a rigorous thermophysical property model is invoked to refresh selected stream properties when temperatures or pressures deviate beyond a predetermined limit from normal operating conditions applying H←(1−α)H_{“old”}++α(H⁰+C_{P}(T−T⁰)) with α ∈ (0,1].

The present inventors propose that different nodes and/or different time periods of a multi-period model are instantiated at different abstraction levels to apply higher fidelity selectively while preserving tractability. For instance, in the near time periods, the models may be represented by [MF, H⁰], and [MF⁰, H] incarnations, while in far time periods the models may be represented by [MF] incarnations.

The present inventors propose that Phase I is formulated as a linear or mixed-integer linear program and Phase II is formulated as a linear program.

The present inventors propose that one or more early time periods may include hybrid node-model incarnations comprise of model-predictive-controller-model integrated with mass and energy balances to support control-aware real-time optimization.

The present inventors propose that the composite algorithm converges in approximately 4-7 iterations to within about 1% deviation from a rigorous reference model across throughput variations between 80% and 125% of nominal capacity.

The present inventors propose that describing composition by component mass flows eliminates nonlinear terms arising from mole-fraction constraints in mixing, splitting, and separation operations.

As described hereinbefore, in an aspect, the disclosure relates to finding consistent solutions to plant models that have different levels of model abstractions (different levels of accuracy) such as planning, scheduling, or operating conditions optimization models. All models are viewed as subsets of one rigorous model, and all are based on the same process network representation. The modelling basis is changed from moles and fractions to mass component flows and local thermophysical properties to increase accuracy at higher abstraction levels, thereby enabling development of hybrid plant models that have accuracy on par with rigorous models. Increasingly more accurate, mutually consistent solutions are computed by iterative solutions of linear subsets of model equations (partitions corresponding to abstraction levels), instead of solving the entire nonlinear model simultaneously. Linear equations parameters are computed (updated) at the solutions of the linear subsets from more accurate models. Such partitioning enables optimization based on linear subsets of a plant model, providing a basis for the development of high-accuracy linear multiperiod planning LP models or MILP models for superstructure optimization or discrete-time scheduling, instead of the MINLP approach to such problems. A hydrogen plant model demonstrates that a highly accurate hybrid model, with accuracy appropriate for real-time optimization, can also be used for multiperiod planning.

In this disclosure, to attain accuracy on par with rigorous models while reducing the nonlinearity, the modeling paradigm is changed from mole flows and mole fractions to component mass flows. Rigorous thermophysical property calculations are replaced by linear local approximations around the normal operating conditions of a particular stream, which leads to flow*unit enthalpy bilinear terms (and other flow*bulk property terms). The node models are hybrid models that describe accurately the operation in the vicinity of normal operating conditions and therefore, are linear. Such plant models can be within 1% of the error relative to the rigorous models.

While the aspects of the present embodiments are illustrated and described as having a certain arrangement of aspects and features, it is understood that any suitable arrangement can be used that retains the functions described with respect to the present embodiments.

Although the foregoing has been described with reference to certain specific embodiments, various modifications thereto will be apparent to those skilled in the art without departing from the spirit and scope of the invention as outlined in the appended claims.

1. A method for optimizing a physical system having plural interconnected pieces of equipment between which matter and energy flow, the method executable on one or more processors, the method comprising:
representing the physical system as a topology comprising plural nodes and plural streams interconnecting the nodes, wherein the nodes are representative of the pieces of equipment and the streams are respectively representative of transfer of at least one of matter and energy from one piece of equipment towards another, each node being associated with plural sets of thermodynamic equations representative of operating behaviour of a corresponding one of the pieces of equipment at different levels of accuracy as to form a node model of the piece of equipment, wherein the plural sets of thermodynamic equations include:
a first set consisting of node model mass-balance equations in which mass flow is a variable;
a second set comprising node model mass-balance and energy-balance equations in which mass flow and unit enthalpy are variables, wherein unit enthalpy in the second set is derived from local material property models; and
a third set comprising node model mass-balance and energy-balance equations in which mass flow and unit enthalpy are variables, wherein unit enthalpy in the third set is derived from rigorous material property models; providing an optimization objective function;
selecting, for each node of the topology, a desired level of accuracy corresponding to one of the sets of thermodynamic equations;
modelling the physical system, comprising generating, from the same topology, sets of modelling equations based on the selected sets of thermodynamic equations;
optimizing the model of the physical system with respect to the optimization objective function by solving the generated sets of modelling equations until a convergence condition is met; and
outputting solutions determined by optimization of the model of the physical system representing operating parameters of the pieces of equipment, for input to the physical system to effect actual operating behaviour thereof.

2. The method of claim 1 wherein the sets of thermodynamic equations further include:
a fourth set comprising linearized node model mass-balance and energy-balance equations in which mass flow is a variable and unit enthalpy is provided as a constant; and
a fifth set comprising linearized node model mass-balance and energy-balance equations in which unit enthalpy, temperature and pressure are variables related by the local material property models.

3. The method of claim 1 wherein unit enthalpy is expressed per unit mass.

4. The method of claim 3 wherein, when a respective one of the streams comprises mass flow, the stream is represented by component mass flows and bulk thermodynamic properties expressed per unit mass.

5. The method of claim 1 wherein the topology is based on a process flow diagram representative of the physical system.

6. A system for optimizing a physical system having plural interconnected pieces of equipment between which matter and energy flow, the system executable on one or more processors, the system comprising:
a topology building module to represent the physical system as a topology comprising plural nodes and plural streams interconnecting the nodes, wherein the nodes are representative of the pieces of equipment and the streams are respectively representative of transfer of at least one of matter and energy from one piece of equipment towards another, each node being associated with plural sets of thermodynamic equations representative of operating behaviour of a corresponding one of the pieces of equipment at different levels of accuracy as to form a node model of the piece of equipment, wherein the plural sets of thermodynamic equations include:
a first set consisting of node model mass-balance equations in which mass flow is a variable;
a second set comprising node model mass-balance and energy-balance equations in which mass flow and unit enthalpy are variables, wherein unit enthalpy in the second set is derived from local material property models; and
a third set comprising node model mass-balance and energy-balance equations in which mass flow and unit enthalpy are variables, wherein unit enthalpy in the third set is derived from rigorous material property models;
an optimization specification module to provide an optimization objective function and to select, for each node of the topology, a desired level of accuracy corresponding to one of the sets of thermodynamic equations;
a model generation module to model the physical system, including to generate, from the same topology, sets of modelling equations based on the selected sets of thermodynamic equations;
an optimization computation module to optimize the model of the physical system with respect to the optimization objective function by solving the generated sets of equations until a convergence condition is met; and
an output module to output solutions determined by optimization of the model of the physical system representing operating parameters of the pieces of equipment, for input to the physical system to effect actual operating behaviour thereof.

7. The system of claim 6 wherein the sets of thermodynamic equations further include:
a fourth set comprising linearized node model mass-balance and energy-balance equations in which mass flow is a variable and unit enthalpy is provided as a constant; and
a fifth set comprising linearized node model mass-balance and energy-balance equations in which unit enthalpy, temperature, and pressure are variables related by the local material property models.

8. The system of claim 6 wherein unit enthalpy is expressed per unit mass.

9. The system of claim 6 wherein, when a respective one of the streams comprises mass flow, the stream is represented by component mass flows and bulk thermodynamic properties expressed per unit mass.

10. The system of claim 6 wherein the topology is based on a process flow diagram representative of the physical system.

11. A method for optimizing a physical system having plural interconnected pieces of equipment between which matter and energy flow, the method executable on one or more processors, the method comprising:
providing, for each piece of equipment, a pair of sets of thermodynamic equations representative of operating behaviour of the piece of equipment at different levels of accuracy as to form a model of the piece of equipment, wherein the sets of thermodynamic equations include:
a first set comprising linearized mass-balance and energy-balance equations in which mass flow is a variable and unit enthalpy is provided as a constant; and
a second set comprising linearized mass-balance and energy-balance equations in which unit enthalpy, temperature, and pressure are variables related by local material property models
modelling the physical system based on a representation of the physical system comprising nodes representative of the pieces of equipment and streams interconnecting the nodes and respectively representative of transfer of at least one of matter and energy from one piece of equipment towards another, each stream being represented by component mass flows and bulk thermodynamic properties expressed per unit mass or by energy flow, wherein modelling comprises:
generating a first set of modelling equations based on the first set of thermodynamic equations for all the nodes in the representation; and
generating a second set of modelling equations based on the second set of thermodynamic equations for all the nodes in the representation;
optimizing the model of the physical system with respect to an optimization objective function by iteratively, until a convergence condition is met:
optimizing the first set of modelling equations where unit enthalpy is set to a prescribed value;
calculating, based on non-linearized equations of the models of the equipment, dependent parameters of mass flow using the mass flow computed from optimization of the first set of modelling equations of a corresponding iteration;
solving the second set of modelling equations for unit enthalpy, temperature and pressure, where mass flow is set to a prescribed value based on optimization of the first set of modelling equations of the corresponding iteration; and
calculating constituent parameters of the first and second sets of modelling equations based on the non-linearized equations of the models of the equipment and material property models and on solutions of the first and second sets of modelling equations of the corresponding iteration, which are usable in a subsequent iteration; and
outputting solutions determined by optimization of the model of the physical system representing operating parameters of the pieces of equipment, for input to the physical system to effect actual operating behaviour thereof.

12. The method of claim 11 wherein, when the linearized mass-balance and energy-balance equations of at least one of the models of the pieces of equipment contain parameters other than mass flow, optimizing the model of the physical system includes, before optimizing the first set of modelling equations in an initial iteration, assigning values associated with normal operating conditions of the physical system to said parameters other than mass flow.

13. The method of claim 11 wherein calculating constituent parameters of the first and second sets of modelling equations based on the non-linearized equations of the models of the equipment and material property models comprises calculating mass flow, pressure and temperature solely based on the non-linearized equations of the models of the equipment and calculating parameters other than mass flow, pressure and temperature solely based on the local material property models.

14. The method of claim 11 further including inputting, to the pieces of equipment, the solutions determined by the optimization of the model, as to effect operation of the pieces of equipment.

15. The method of claim 11 wherein the representation of the physical system is in the form of a topology based on a process flow diagram of the physical system.

16. The method of claim 11 wherein the convergence condition comprises a mass flow convergence condition checked after optimizing the first set of modelling equations.

17. The method of claim 16 wherein solving the second set of modelling equations is performed after convergence of optimization of the first set of modelling equations.

18. The method of claim 16 wherein the convergence condition comprises an energy flow convergence condition checked after solving the second set of modelling equations, and optimization is complete when both the mass flow and energy flow convergence conditions are met.

19. A system for optimizing a physical system having plural interconnected pieces of equipment between which matter and energy flow, the system executable on one or more processors, the system comprising:
a modelling module to:
provide, for each piece of equipment, a pair of sets of thermodynamic equations representative of operating behaviour of the piece of equipment at different levels of accuracy as to form a model of the piece of equipment, wherein the sets of thermodynamic equations include:
a first set comprising linearized mass-balance and energy-balance equations in which mass flow is a variable and unit enthalpy is provided as a constant; and
a second set comprising linearized mass-balance and energy-balance equations in which unit enthalpy, temperature, and pressure are variables related by local material property models;
model the physical system based on a representation of the physical system comprising nodes representative of the pieces of equipment and streams interconnecting the nodes and respectively representative of transfer of at least one of matter and energy from one piece of equipment towards another, each stream being represented by component mass flows and bulk thermodynamic properties expressed per unit mass or by energy flow, wherein modelling comprises:
generating a first set of modelling equations based on the first set of thermodynamic equations for all the nodes in the representation; and
generating a second set of modelling equations based on the second set of thermodynamic equations for all the nodes in the representation;
an optimization module to optimize the model of the physical system with respect to an optimization objective function by iteratively, until a convergence condition is met:
optimizing the first set of modelling equations where unit enthalpy is set to a prescribed value;
calculating, based on non-linearized equations of the models of the equipment, dependent parameters of mass flow using the mass flow computed from optimization of the first set of modelling equations of a corresponding iteration;
solving the second set of modelling equations for unit enthalpy, temperature and pressure, where mass flow is set to a prescribed value based on optimization of the first set of modelling equations of the corresponding iteration; and
calculating constituent parameters of the first and second sets of modelling equations based on the non-linearized equations of the models of the equipment and material property models and on solutions of the first and second sets of modelling equations of the corresponding iteration, which are usable in a subsequent iteration; and
an output module to output solutions determined by optimization of the model of the physical system representing operating parameters of the pieces of equipment, for input to the physical system to effect actual operating behaviour thereof.

20. The system of claim 19 wherein, when the linearized mass-balance and energy-balance equations of at least one of the models of the pieces of equipment contain parameters other than mass flow, the optimization module is further configured to assign values associated with normal operating conditions of an operating range of the physical system to parameters other than mass flow before optimizing the first set of modelling equations in an initial iteration.
